(19) United States
(12) Patent Application Publication
(10) Pub. No.: US 2002/0036978 A1
(43) Pub. Date: Mar. 28, 2002

(54) OPTICAL INFORMATION RECORDING MEDIUM AND METHOD OF PRODUCING A MASTER AND STAMPERS THEREFOR

(76) Inventor: AKIHIKO SHIMIZU, YOKOHAMA-SHI (JP)

Correspondence Address: IVAN S KAVRUKOV, COOPER AND DUNHAM, 1185 AVENUE OF THE AMERICAS, NEW YORK, NY, 10036

(21) Appl. No.: 09/140,975

(22) Filed: Aug. 27, 1998

(30) Foreign Application Priority Data
Aug. 27, 1997 (JP) 09-230696

(51) Int. Cl. G11B 7/24

(52) U.S. Cl. 369/275.4

(57) ABSTRACT

The invention relates to optical information recording medium and method of exposing original board. Even though phase pits representing pre-format information exist on the same position on the adjacent information recording tracks, the phase pit can be surely reproduced utilizing a push-pull method. In the structure recording medium, the center of phase pit coincides with the track center of groove, the groove widths of the groove and the phase pit are equal to each other, the groove depths of both are also equal to each other, and the inclination angles of the phase pit are different from each other at the both-sides edge portion in the radius direction. Consequently, only by making the inclination angles thereof different from each other at the both-sides edge portion in the radius direction and thereby obtaining the shape of groove cross section which is asymmetrical at the both sides of the track center, the shape pit does not turn out to be connected to the adjacent groove, and thereby the phase pit can be stably reproduced without being affected by the mutual interference therebetween even when the phase pits are adjacently arranged in the radius direction.

### BACKGROUND

1. Field

This patent specification relates to an optical information recording medium such as a phase-change type optical disk, and to a method of producing a master amd stampers therefor.

2. Background

Optical recording media such as phase-change type optical recording meda, typically typically have synchronization signals and/or address or other information (often called “pre-format information”) recorded as phase pits on the disc as a part of the disc manufacturing process. When the disc is formed by injection molding using stampers made from masters, such information is recored on the master by forming correponding phase pits therein.

Pre-format information has been recorded in different ways. One example is the wobble pit method, and others involve varying the length, distance, and positions of phase pits.

Difficulties arise with using the known methods of recording phase pits when an effort is made to increase the recording capacity of the optical disk. Using the wobble pit method imposes a limitation on how small the track pitch (the spacing of recording tracks) can be and thus limits recording capacity. Using other methods can also impose limitations when recording capacity is increased, because the need remains to ensure adequate S/N (signal to noise ratio).

Japanese Laid-open Patent Publication No. 9-17029/1997 proposes forming phase pit on the lands that are between the grooves that carry the recording track. FIGS. 23a through 23c schematically illustrate this approach, and show phase pits P is formed on the lands L that are between the recording grooves G. As illustrated in FIGS. 23a through 23c, the phase pits P connect in the radial direction respective adjacent grooves where the recording tracks are. Viewed in the track direction, the phase pits resemble a ladder.

Such phase pits P can be read with a photodiode pair arranged in the radial direction (in the direction perpendicular to the track direction) of the optical disk. The diode pair and its associated electronics receive light energy modulated by the phase pits and process it into a differential electrical signal. Details of this process can be found in connection with FIG. 8 in the published specification of Japanese Laid-open Patent Publication No. 9-17029/1997. In this arrangement, if two phase pits P flank a groove G at the same track position, the pre-format information the two phase pits represent may be read at the same time to cause undesirable cross-talk. To aleviate this problem, two types of pre-format information are represented by respective phase pits P—one for even information EVEN and another for odd information ODD. When, in such arrangement, cross-talk could occur, different patterns (ODD and EVEN) are recorded or formed next to each other in the radial direction on the optical information recording medium. Refer to FIG. 2 in the published specification of Japanese Laid-open Patent Publication No. 9-17029/1997 and the explanation corresponding thereto.

### SUMMARY

As discussed in the proposal in the aforementioned published specification, two types of pre-format information represented by respective phase pits P are formed in order to aleviate the problem of the cross-talk. However, it can be difficult to determine the position at which cross-talk can occur (the position where phase pits P will be radially adjacent on two lands L flanking the same track of a groove G) and then change over from one to the other of the even pattern EVEN and the odd pattern ODD. If there were no errors in counting tracks or revolutions or determining positions along a track in the mastering process, the positions at which cross-talk can occur can be calculated and the phase pit pattern of the pre-format information can be accurately encoded by changing from one to the other of the even pattern EVEN and the odd pattern ODD. However, if such an error occurs in the mastering process, even if the error is small (e.g., no larger than 0.1%), cross-talk may not be sufficiently aleviated.

In such a situation, as mentioned heretofore, in practice it is necessary to determine the position at which cross-talk could occur by monitoring the revolutions of the master as it is exposed for form grooves and phase pits and to change over between the even pattern EVEN and the odd pattern ODD. However, since the length of the phase pit P in the direction of the track is very small, for instance, in the order of submicron, the error detection has to be performed in the order of ns. In addition, other factors can make it difficult to determine exactly where cross-talk could occur and to take the appropriate measures to aleviate it, such as imprecisions in the mastering equipment.

There is a method of reading phase pit pre-format information employing a push-pull signal (difference signal), although such method is not described in detail in the aforementioned published specification. Some principles of reading (reproducing) the pre-format information are described hereinafter, referring to FIGS. 24(a), 24(b), and FIGS. 25(a), 25(b).

FIG. 24(a) is a plan view of a phase pit and FIG. 24(b) is a diagram illustrating a waveform of a push-pull signal relating thereto. FIG. 24(b) illustrates the waveform of a push-pull signal generated from the vicinity of the phase pit P by a reading beam B traversing the disk generally in the radius direction thereof, as illustrated in FIG. 24(a). The push-pull signal approximates a sine wave (sinusoidal wave) with a period corresponding to the track pitch TP. Since in the vicinity of the phase pit P in FIG. 24(a) there is asymmetry in the radial direction relative the the track center, there is a shift related to the phase pit P (in FIGS. 24(a) and 24(b), shown by a dot-and-dash line), by a distance s in the radius direction from the track center of the groove G.

For this reason, when controlling the tracking along the groove G and reproducing a signal as shown in FIG. 25(a), a peak represented by a magnitude A appears in the push-pull signal for the position of the phase pit P as illustrated in FIG. 25(b). If the presence or absence of the peak A or the location of such a peak is detected, the pre-format information represented by the phase pit P can be reproduced.

However, when two phase pits P are radially adjacent, on two lands flanking the same groove G, for example at tracks Tr3 and Tr4 shown in FIG. 23(b),[refer to FIG. 26(a)], even though the phase pits P exist, there is no radial asymmetry along track Tr4. As is apparent from the push-pull signal shown in FIG. 26(b), the shift s does not occur at all. Consequently, the peak A may not appear at all on the push-pull signal.

Thus, when two phase pits are radially adjacent, on the two lands flanking the same groove G, there can be a problem with reading the pre-format information represented by those phase pits. In an effort to aleviate this problem, two different pattern; even pattern EVEN and odd pattern ODD, are used for the phase pit information in order to reduce cross-talk effects.

The optical recording media and method disclosed in this patent specification are designed to overcome such problems and bring about other improvements.

One aspect of the disclosure pertains to solving problems encountered in the known approaches and providing improvement thereon.

Another aspect of the disclosure pretains to providing an optical information recording medium capable of reliably reproducing the phase pit information by utilizing, for instance, a push-pull method, etc., without being significantly affected by mutual interference of two phase pits that are radially adjacent to each other.

Yet another aspect of the disclosure pertains to providing a method of exposing a master for use in manufacturing optical information recording medium.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1(a) through 1(c) illustrate an optical information recording medium of a first embodiment, wherein FIG. 1(a) is a plan view of the recording medium, FIG. 1(b) is a cross-sectional view taken along line 1 and FIG. 1(c) is a cross-sectional view taken along line 2;

FIGS. 2(a) through 2(f) are process diagrams illustrating a master and stamper manufacturing processes;

FIG. 3 is a perspective view illustrating exposure of a master;

FIGS. 4(a) through 4(c) are explanatory diagrams for illustrating a method of exposing a master;

FIGS. 5(a) through 5(c) illustrate an optical information recording medium of a second embodiment, wherein FIG. 5(a) is a plan view of the recording medium, FIG. 5(b) is a cross-sectional view taken along line land FIG. 5(c) is a cross-sectional view taken along line 2;

FIGS. 6(a) and 6(b) are explanatory diagrams for illustrating a method of exposing a master;

FIG. 7 is an explanatory diagram for illustrating a method of exposing a master for the third embodiment;

FIGS. 8(a) through 8(c) illustrate an optical information recording medium of a fourth embodiment, wherein FIG. 8(a) is a plan view of the recording medium, FIG. 8(b) is a cross-sectional view taken along line 1 and FIG. 8(c) is a cross-sectional view taken along line 2;

FIGS. 9(a) and 9(b) are explanatory diagrams for illustrating a method of exposing a master;

FIGS. 10(a) through 10(c) illustrate an optical information recording medium of a fifth embodiment, wherein FIG. 10(a) is a plan view of the recording medium, FIG. 10(b) is a cross-sectional view taken along line 1 and FIG. 10(c) is a cross-sectional view taken along line 2;

FIGS. 11(a) and 11(b) are explanatory diagrams for illustrating a method of exposing a master;

FIGS. 12(a) through 12(c) illustrate an optical information recording medium of a sixth embodiment, wherein FIG. 12(a) is a plan view of the recording medium, FIG. 12(b) is a cross-sectional view taken along line 1 and FIG. 12(c) is a cross-sectional view taken along line 2;

FIGS. 13(a) and 13(b) are explanatory diagrams for illustrating a method of exposing a master;

FIG. 14 is an explanatory diagram for illustrating a method of exposing a master for a seventh embodiment;

FIGS. 15(a) through 15(c) illustrate an optical information recording medium of an eighth embodiment, wherein FIG. 15(a) is a plan view of the recording medium, FIG. 15(b) is a cross-sectional view taken along line 1 and FIG. 15(c) is a cross-sectional view taken along line 2;

FIG. 16 is an explanatory diagram for illustrating a method of exposing a ,aster;

FIGS. 17(a) and 17(b) illustrates a first example, wherein FIG. 17(a) is an LPP property diagram (graph) and FIG. 17(b) is an explanatory diagram for illustrating conditions thereof;

FIGS. 18(a) and 18(b) illustrate a second example, wherein FIG. 18(a) is an LPP property diagram (graph) and FIG. 18(b) is an explanatory diagram for illustrating conditions thereof;

FIGS. 19(a) and 19(b) illustrate a third example, wherein FIG. 19(a) is an LPP property diagram (graph) and FIG. 19(b) is an explanatory diagram for illustrating conditions thereof;

FIGS. 20(a) and 20(b) illustrate a fourth example, wherein FIG. 20(a) is an LPP property diagram (graph) and FIG. 20(b) is an explanatory diagram for illustrating conditions thereof;

FIGS. 21(a) and 21(b) illustrate a fifth example, wherein FIG. 21(a) is an LPP property diagram (graph) and FIG. 21(b) is an explanatory diagram for illustrating conditions thereof;

FIGS. 22(a) and 22(b) illustrate a sixth example, wherein FIG. 22(a) is an LPP property diagram (graph) and FIG. 22(b) is an explanatory diagram for illustrating conditions thereof;

FIGS. 23(a) through 23(c) illustrate an optical information recording medium of the conventional optical information recording medium, wherein FIG. 23(a) is a plan view of the recording medium, FIG. 23(b) is a cross-sectional view taken along line 1 and FIG. 23(c) is a cross-sectional view taken along line 2;

FIGS. 24(a) and 24(b) illustrate principles of reproducing the phase pit in a related-art recording medium, wherein FIG. 24(a) is a plan view of the phase pit and FIG. 24(b) is a waveform diagram of the push-pull signal;

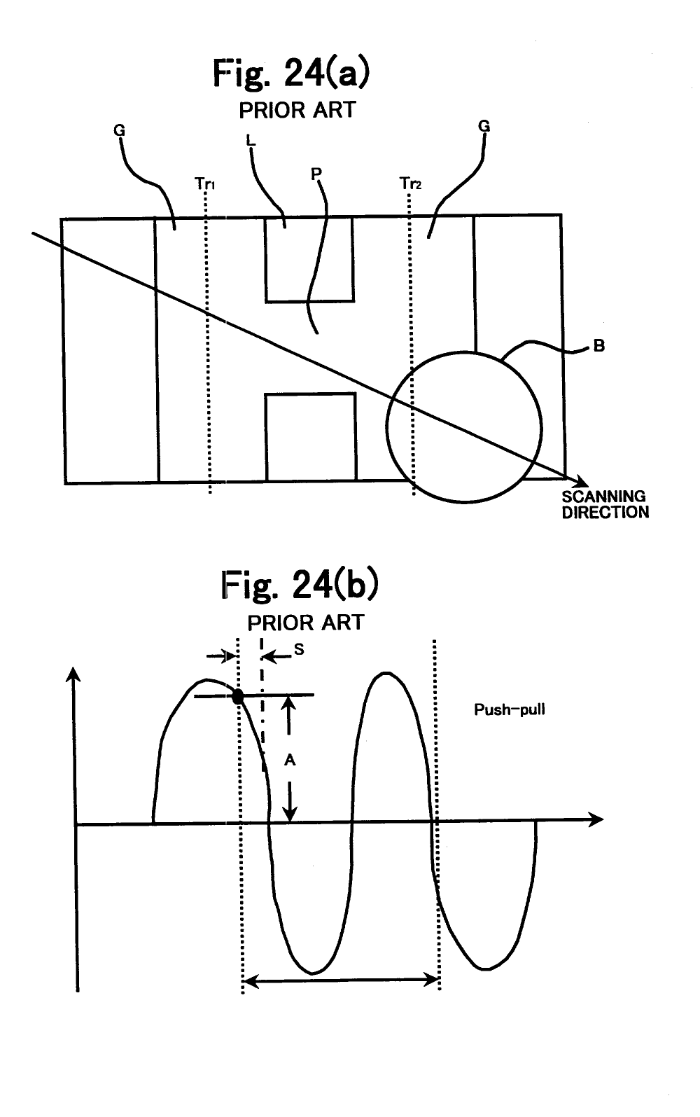

FIGS. 25(a) and 25(b) illustrate principles of reproducing the phase pit accompanying the tracking in a related-art recording medium, wherein FIG. 25(a) is a plan view of the phase pit and FIG. 25(b) is a waveform diagram of the push-pull signal; and

FIGS. 26(a) and 26(b) illustrate the case of a related-art recording medium in which the phase pit cannot be reproduced reliably, wherein FIG. 26(a) is a plan view of the phase pit and FIG. 26(b) is a waveform diagram of the push-pull signal.

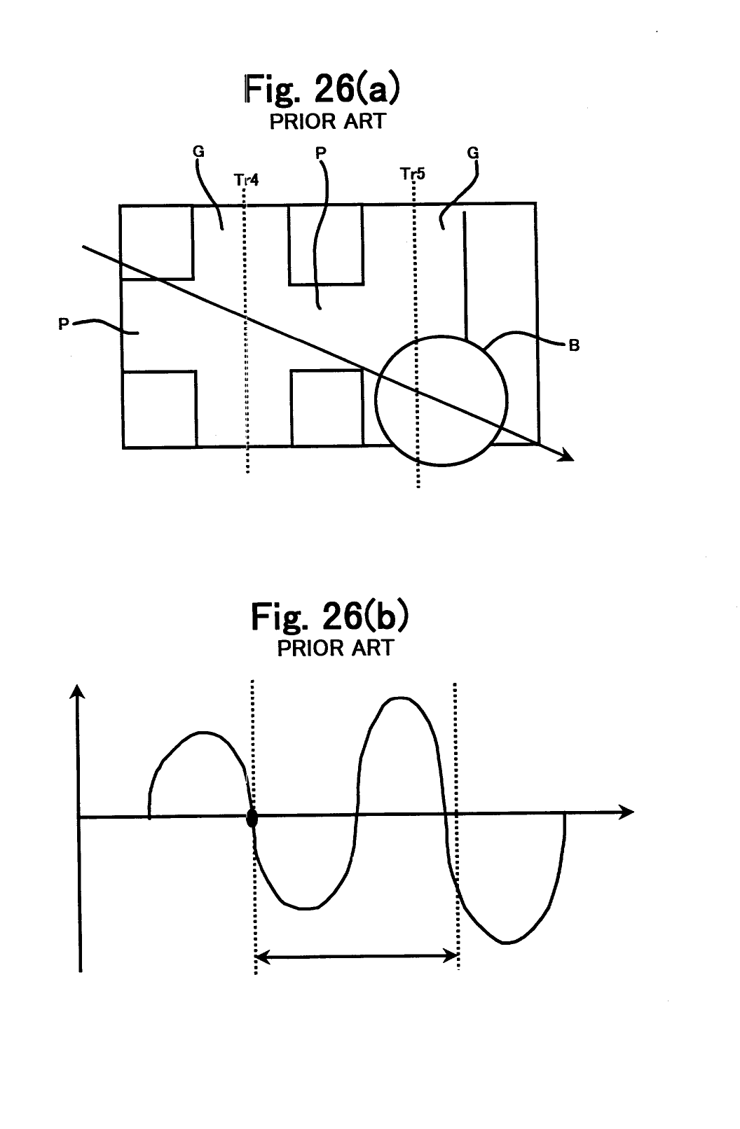

### DESCRIPTION OF PREFERRED EMBODIMENTS

One embodiments relates to an optical information recording medium in which a track for recording the information is a groove and pre-format information is formed thereat as a phase pit. The phase pit is formed at the groove and its radial cross section which is asymmetrical relative to the track center of the groove.

Consequently, in such structure, since the phase pits are formed at the groove and the shape of those phase pits in radial section is asymmetrical relative to the groove track center, when tracking control is carried out utilizing the push-pull method, the signals reproduced (read) from the groove and the phase pit can be distinguished from each other so that the phase pit information can bee read (reproduced).

The phase pit is formed at the groove, and even when two phase pits are radially adjacent at adjacent grooves, they do not cause significant mutual interference. The phase pits are in the groove area and even if they protrude somewhat in the radial direction from the groove area, they can still be read reliably because they do not extend into the area of an adgacent groove.

Another embodiment relates to an optical information recording medium in which a track for recording the information is a groove and pre-format information is formed thereat as phase pits. The track center of the groove is the same as the center of the phase pit, the width of the groove is the same as that of the phase pit, and the groove depth of the groove is same as that of the phase pit. The inclination angles of the sides of the phase pit in radial section are different from each other.

Consequently, only by causing the inclination angles of the sides of the phase pit in radial section to differ from each other and thereby making asymmetric the shape of the groove cross sections relative to the track center, the phase pit can be kept from extending into an adjacent groove, and phase pits that are radially adjacent can still be read out reliably.

Another embodiment relates to an optical information recording medium in which a track for recording the information is a groove and pre-format information is formed thereon as phase pits. The center of the phase pit is shifted radially from the track center of the groove, the width of the phase pit is less than that of the groove, and the inclination angles of the sides of the phase pit in radial section are equal to each other.

Consequently, only by reducing the width of the phase pit relative to the width of the groove, shifting the center of the phase pit radially from the track center, and causing the shape of the phase pit to be asymmetric relative to the track center, the phase pit is prevented from extending into the groove(s) of the track(s) adjacent thereto and can be read reliably even when radially adjacent to another phase pit.

Another embodiment relates to an optical information recording medium in which a track for recording the information is a groove and pre-format information is formed thereon as phase pits. The center of the phase pit is shifted radially from the track center of the groove, the width of the phase pit is greater than that of the groove but the phase pit does not extend radially into an adjacent groove, the groove depth of the groove is equal to that of the phase pit, and the inclination angles of sodes of the phase pit in radial section are different from each other.

Consequently, only by causing the inclination angles of the sides of the phase pit in radial section to differ from each other, widening the groove width of the phase pit but not so much as to make the phase pit extend into an adjacent groove, and making asymmetric the shape of the phase pit in radial section relative to the track center, the phase pit can be reliably read even when radially adjacent to another phase pit.

Another embodiment relates to an optical information recording medium in which a track for recording the information is a groove and pre-format information is formed thereon as phase pits. The center of the phase pit is shifted radially from the track center of the groove without extending the phase pit into an adjacent groove, the width of the groove is equal to that of the phase pit, and the groove depth of the groove is also equal to that of the phase pit, and the inclination angles of the sides of the phase pit in radial section are different from each other.

Consequently, only by causing the inclination angles of the sides of the phase pit in radial section to differ from each other, shifting the phase pit radially without extending it into an adjacent groove, and making asymmetrical the shape of the phase pit in radial section relative to the track center, the phase pit can be read reliably.

Another embodiment relates to an optical information recording medium in which a track for recording the information is a groove and pre-format information is formed thereon as phase pits. The center of the phase pit is shifted radially from the track center, the width of the phase pit is greater than that of the groove without allowing the phase pit to extend into an adjacent groove, the depth of the groove is equal to that of the phase pit, and the inclination angles of the sides of the phase pit in radial section are equal to each other.

Consequently, only by widening the phase pit wothout allowing it to extend into an adjacent groove, and making asymmetric the shape of the phase pit radial section relative to the track center, the phase pit can be read reliable even when radially adjacent to anothe phase pit.

Another embodiment reelates to an optical information recording medium in which a track for recording the information is a groove and pre-format information is formed thereon as phase pits. The center of the phase pit is shifted radially from the track center of the groove without extending the phase pit into an adjacent groove, the width of the groove is equal to that of the phase pit, and the depth of the groove is also equal to that of the phase pit, and the inclination angles of the sides of the phase pit in radial section are equal to each other.

Consequently, only by shifting the phase pit radially without extending it into an adjacent groove, and making asymmetric the shape of the phase pit in radial section relative to the track center, the phase pit can be read reliably even when radially adjacent to another phase pit.

Another embodiment relates to a method of exposing a master for manufacturing the optical information recording medium as defined in the second embodiment and comprises the steps of: using two exposing light beams, namely, a groove exposing light beam centered at the center of a track and a phase pit exposing light beam centered at a position radially spaced from the center of the track; exposing a master by use of the groove exposing light beam when forming a groove; and simultaneously exposing the master by use of the groove exposing light beam having a lower light intensity than when exposing a groove and the phase pit exposing light beam having another light intensity lower still than that of the groove exposing light beam, when exposing the phase pit.

Because the master can be exposed for forming the groove and the phase pit by controlling the distance between the two exposing light beam and the light intensities of the exposing light beams, the phase pit can be formed reliably and precisely.

Another embodiment relates to a method of exposing a master for manufacturing the optical information recording medium as defined in the third embodiment and comprises the steps of: using two exposing light beams having equal light intensities and spaced from each other radially; arranging the two exposing light beams radially symmetrically about the center of a track and simultaneously exposing the master to the two beams when exposing the groove; and shifting only one of the exposing light beams radially to reduce the spacing between the two beams and simultaneously exposing the master for exposing the phase pit.

Because the distance between the two beams and the light intensities of the exposing light beams can be controlled, the phase pits can be formed reliably and precisely.

Another embodiment relates to a method of exposing a master for manufacturing the optical information recording medium as defined in the third embodiment comprises the steps of: centering an exposing light beam at the center of a track and exposing the master to form a groove; and shifting the exposing light beam radialy from the center of the track and exposing the master with lower light intensity to form the phase pit.

Because of the control over the radial shifting of the exposing light beam and the light intensity of the exposing light beam, the phase pit can be formed reliably and precisely.

Another embodiment relates to a method of exposing a master for manufacturing the optical information recording medium as defined in the fourth embodiment and comprises the steps of: using two exposing light beams, a groove exposing light beam centered at the center of track and a phase pit exposing light beam centered at a position radially shifted from the center of the track; exposing a master by use of the groove exposing light beam to form a groove; and simultaneously exposing the master by use of the groove exposing light beam having a lower light intensity and the phase pit exposing light beam having a lower still light intensity to form a phase pit.

Because of the control over the distance between the two exposing light beams and the light intensities of the exposing light beams, the phase pit can be formed reliably and precisely.

Another embodiment relates to a method of exposing a master for manufacturing the optical information recording medium as defined in the fifth embodiment and comprises the steps of: using two exposing light beams, a groove exposing light beam centered at the center of track and a phase pit exposing light beam at a position shifted radially from the center of the track; exposing a master by use of the groove exposing light beam when forming a groove; and shifting radially the groove exposing light beam and lowering its light intensity and using it together with the phase pit exposing light beamd to expose the master for forming a phase pit.

Because of the control over the distance between the two exposing light beams and the light intensities of the exposing light beams, the phase pit can be formed reliably and precisely.

Another embodiment relates to a method of exposing a mster for manufacturing the optical information recording medium as defined in the sixth embodiment and comprises the steps of: using an exposing light beam at the center of a track and exposing the master therewith for forming a groove; and shifting radially the exposing light beam exposing the master at a higher light intensity for forming the phase pits.

Beacause of the control over the shifting and the light intensity of the exposing light beams, the phase pit can be formed well.

Another embodiment relates to a method of exposing a master for manufacturing the optical information recording medium as defined in the sixth embodiment and comprises the steps of: using two exposing light beams having equal light intensity and spaced from each other radially; arranging the two exposing light beams symmetrical radially relative to the center of track and simultaneously exposing by use of the beams when forming a groove; and shifting only one of the exposing light beams to increase its distance from the other beam and simultaneously exposing the original board to form the phase pit reliabley.

Another embodiment relates to a method of exposing a master for manufacturing the optical information recording medium as defined in the seventh embodiment and comprises the steps of: using an exposing light beam of constant light intensity; disposing the exposing light beam at the center of the track and exposing the original board to form a groove; and shifting the exposing light beam in the radius direction from the center of the track and exposing the master to form a phase pit reliably.

First Embodiment

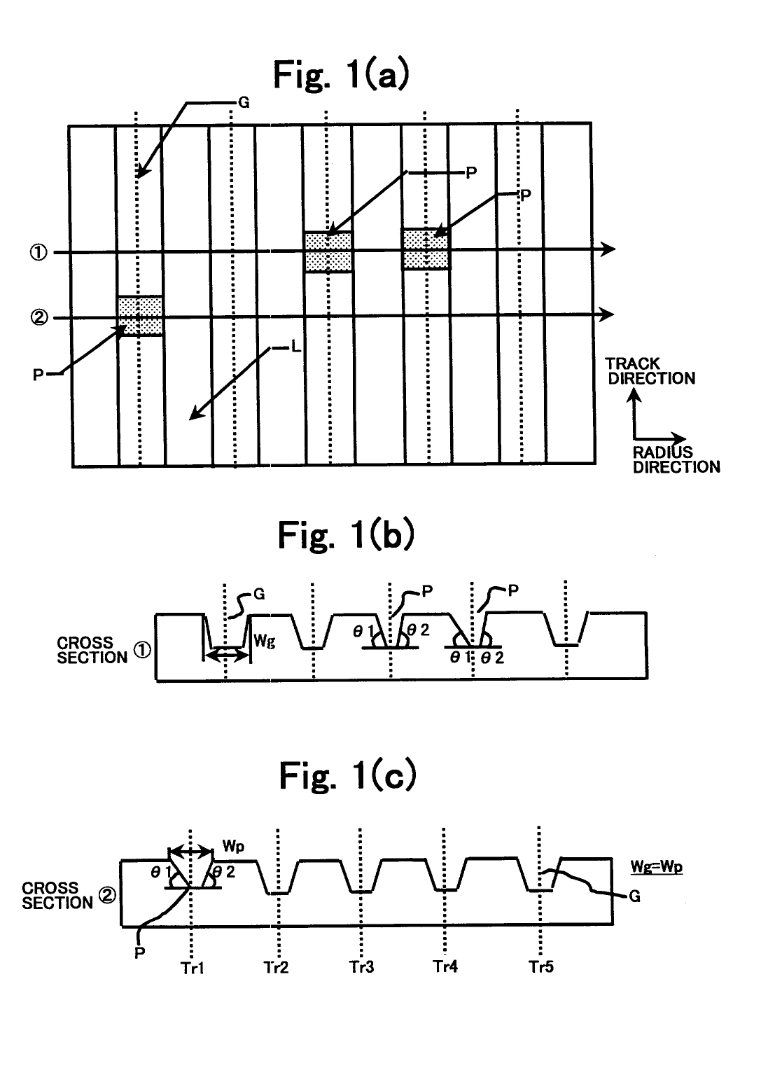

A first embodiment is described hereinafter referring to FIGS. 1(a) through 4(c). In the first as well as in the other embodiments, the groove employed as the information. recording track is labelled G, the land between adjacent grooves G is L, the phase pit signifying pre-format information is P, the groove width of the groove G is Wg, and the groove width of the phase pit P is Wp.

In the optical information recording medium of the first embodiment, the phase pit P is formed on the groove G. The inclination angles on the respective right and left sides of the phase pit P in the radius direction (perpendicular to the length of the track Tr) are made different from each other. Namely, assuming that the respective inclination angles of the sides of the phase pit P are θ1 and θ2, those angles are not equal (θ1≠θ2, here θ1<θ2).

The inclination angles of the sides of the groove G are set to θ2. In other respects, the phase pit P and the groove G are the same. Namely, the groove width Wg at the top of the groove G and the groove width Wp at the top of the phase pit P are the same (Wg=Wp), although this need not always be the case. The groove G and the phase pit P are equally deep. Furthermore, the center of the width Wp of the phase pit P coincides with the track center of the groove G.

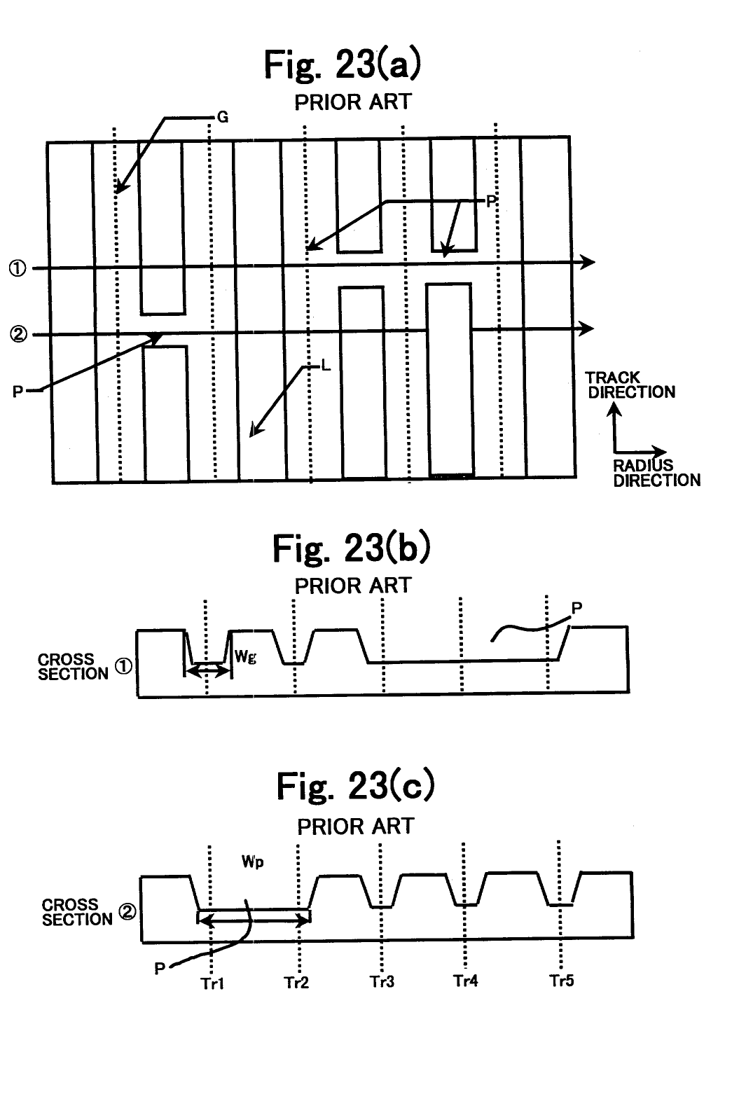

As compared with a conventional optical information recording medium as shown in FIGS. 23(a) through 23(c), the phase pit P of the first embodiment is directly formed on the groove G instead of forming it on the land L, and the inclination angles θ1 and θ2 of the sides of the phase pit P are made different from each other. Thereby, the cross section of the phase pit P is made asymmetrical relative to the center of track G. Consequently, for instance as shown at tracks Tr3 and Tr4, even though there are two phase pits P next to each other in the radial direciton at two adjacent tracks G, it is possible to arrange those phase pits P, with their asymmetrical shape, next to each other in the radial direction. Therefore, those phase pits P can be stably reproduced and detected from the push-pull signal without being affected by the interference between them.

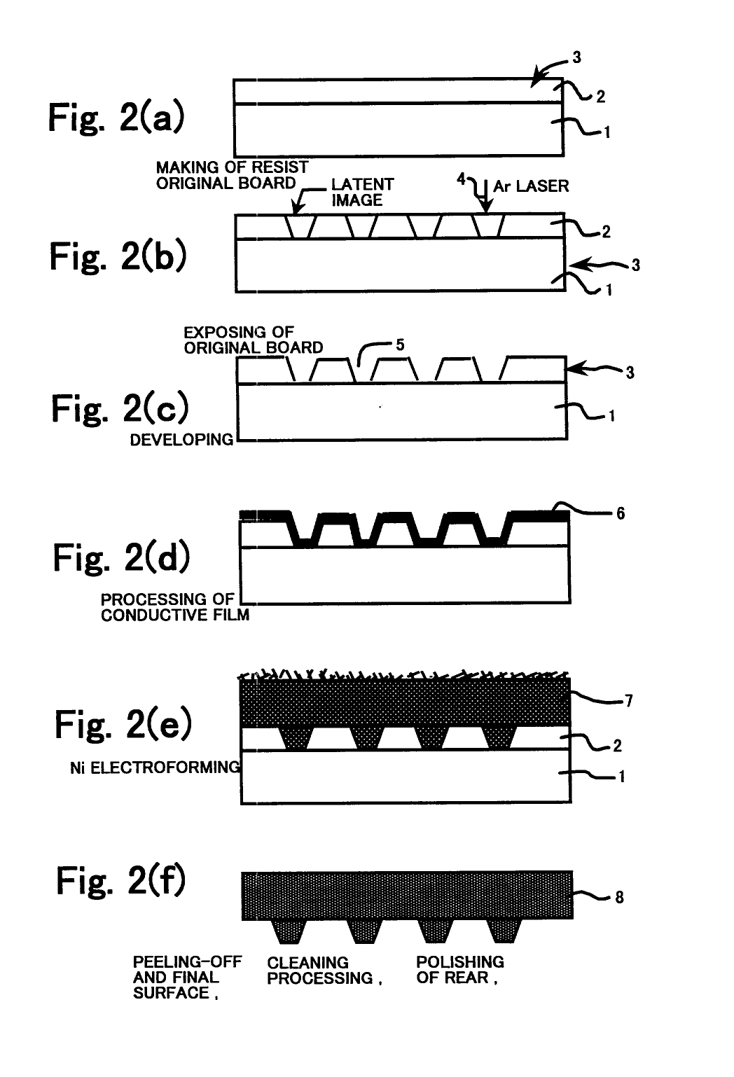

Therefore, a large number of such optical information recording discs can be replicated utilizing an injection molding method using a metal “stamper”. Such a stamper can be made in accordance with the stamper manufacturing process as illustrated in FIG. 2. In this process, first a photoresist film 2 is applied and cured on a glass master substrate 1 to start forming a glass master 3. Refer to FIG. 2(a). Next, the master 3 is exposed to a focused laser beam, e.g., an Ar laser 4 in this embodiment, to form a latent image therein corresponding to the location of grooves G. Refer to FIG. 2(b). The exposed resist-covered master 3 is developed to thereby form a groove pattern 5 in the photoresist film 2. Refer to FIG. 2(c). An Ni film is formed thereon, e.g., by sputtering, to thereby form an electrically conductive film 6 on the surface of the master 3 having the groove pattern 5 formed on the photoresist film 2 thereof. Refer to FIG. 2(d). A thicker Ni layer is fromed, e.g., by electroilitic deposition, on the conductive film 6 to thereby form a Ni plate 7 thereon. Refer to FIG. 2(e). The Ni plate 7 is peeled off form the glass base plate 1. The plate 7 thus peeled off is completed as a stamper 8 by cleaning, rear surface polishing, inner diameter surface treatment, and outer diameter surface treatment. Refer to FIG. 2(f).

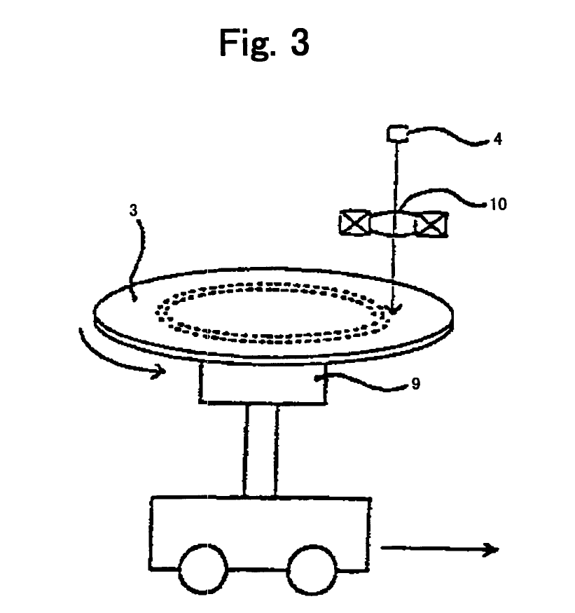

The process of exposing the photoresist layer on master 3, illustrated in FIG. 2(b), is further illustrated in FIG. 3. The master 3 is rotated by a turn table 9 while being conveyed laterally, and the laser beam of an Ar laser 4 is focused onto the resist layer on master 3. In this way, a groove pattern 5 matching the position of the grooves G is formed, e.g., as a spiral. The reference numeral 10 identifies an object lens.

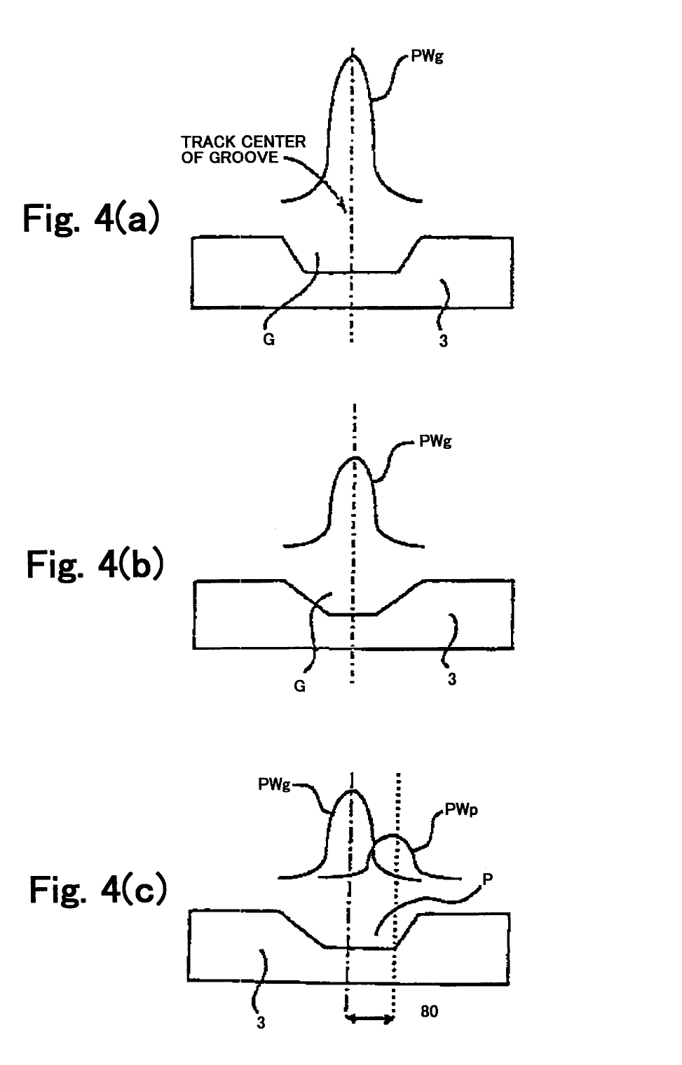

The exposure of the resist layer on the master 3 to form a latent image of recording track grooves G and phase pits P is further illustrated in FIGS. 4(a) through 4(c). In the present embodiment, two beams of exposing light are employed for exposing the groove G and the phase pit P. One of them is a groove exposing light beam PWg aligned with the track center of the groove G, and the other is a phase pit exposing light beam PWp spaced or shifted from beam PWg by a distance BD in the radius direction from the center of the track.

When only a groove G is being exposed, the resist on master 3 is exposed by use of only the groove exposing light beam PWg centered on the track center, as shown by dot-and-dash line in FIG. 4(a). When the light intensity of the groove exposing light beam PWg is decreased, the sides of the groove G have smaller inclination angles, as illustrated in FIG. 4(b). This illustrates the principle of controlling the inclination angles of the groove sides by controlling the light intensity of the exposing light beam. When a phase pit is exposed, the light intensity of the groove exposing light beam PWg is reduced as compared with exposing a groove G, as illustrated in FIG. 4(c), and the phase pit exposing light beam PWp spaced in the radial direction by the distance BD from the center of the track is used concurrently increase the inclination angle of one side [in FIG. 4(c), right side], so that the resist on master 3 is exposed at the same time with the two exposing light beams PWg and PWp. As seen in FIG. 4(c), the light intensity of the phase pit exposing light beam TWp is set to a value smaller than the light intensity of the groove exposing light beam PWg.

In this manner, it is possible to form a phase pit P such that, as seen in FIGS. 1(b) and 1(c), its sides are asymmetrical relative to the track center of the groove G, the groove width Wp of the phase pit P is substantially the same as the groove width Wg of the groove G, and the relationship between the inclination angles θ1 and θ2 at the right and left sides of the phase pit P becomes:

θ1<θ2.

Second Embodiment

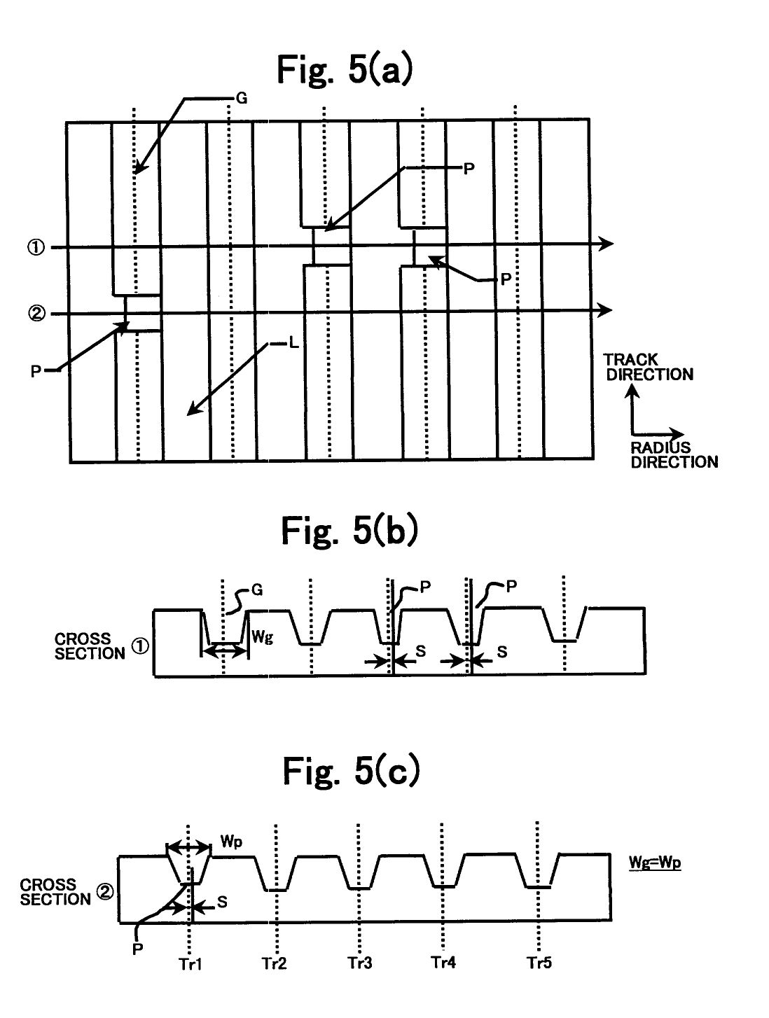

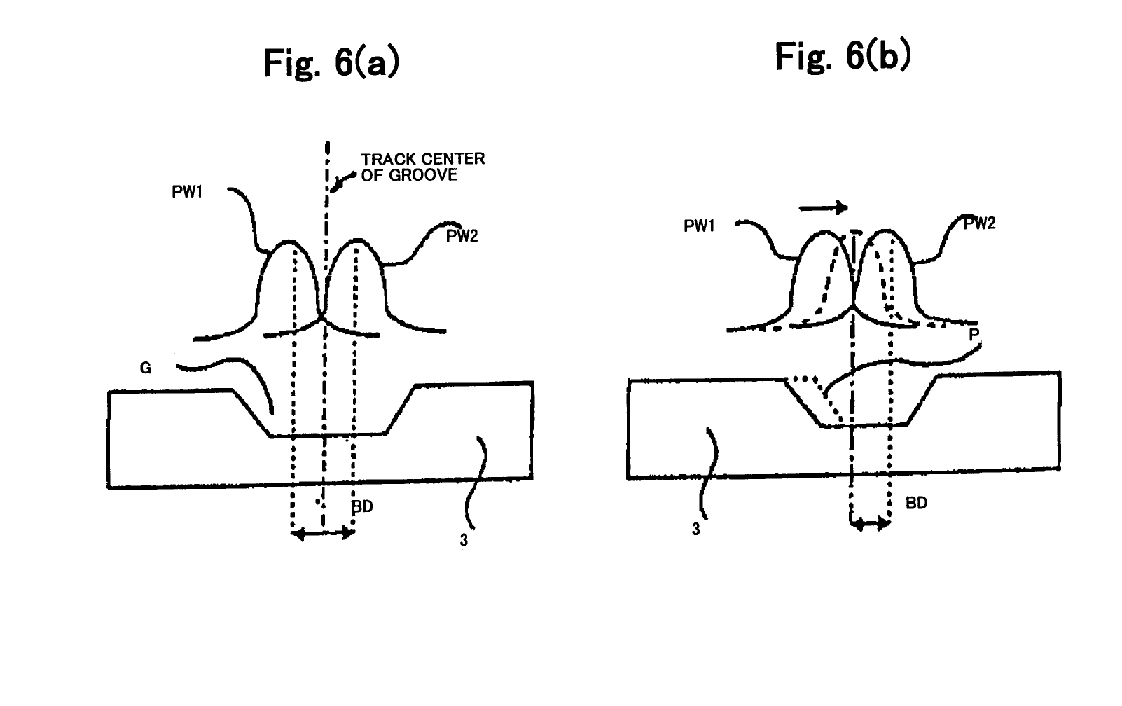

A second embodiment is described hereinafter referring to FIGS. 5a through 6(b).

In the optical information recording medium of the second embodiments, the phase pit P is formed on the groove G, and the center of the phase pit P (the center of the groove cross section in the radial direction) is shifted by the distance s in the radius direction from the track center of the groove G. Furthermore, the groove width Wp of the phase pit P is set to a value smaller than that of the groove width Wg (Wg>Wp), and the groove depths of the phase pit P and the groove G are set to an equal value.

The inclination angles of the sides of the phase pit P in a radial section perpendicular to the length of the track Tr, are also set to an equal value. (The inclination angles of the sides of the groove G in a similar section are set to another equal value.)

As compared with a conventional optical information recording medium as shown in FIG. 23, in this second embodiment the phase pit P is not formed on the land L, and instead the groove width Wp of the phase pit P is made somewhat smaller than that (Wg) of the groove G and the center of the phase pit P is shifted by the distance s from the track center, and thereby the cross section of the phase pit P can be made offset from the track center of the groove G. Consequently, for instance as shown in the tracks Tr3 and Tr4, two phase pits P exist side-by-side radially at adjacent tracks. Those phase pits P can be stably reproduced and detected from the push-pull signal without interfereing with each other.

A method of exposing the resist on master 3 for forming the groove G including the phase pit P of this second embodiment status, illustrated in FIGS. 5(a)-5(c), is described hereinafter referring to FIGS. 6(a) and 6(b). Two exposing light beams PW1 and PW2 are employed for exposing the groove G and the phase pit P. The light intensities of those exposing light beams PW1 and PW2 are set to a same value but the two beams are offset from each other by the distance BD in the radius direction.

When exposing a groove G, the exposing light beams PW1 and PW2 are at position flanking the track center of the groove G symmetrically in the radius direction (the track center isshown by the dot-and-dash line), and the resist on master 3 is exposed at the same time by the two exposing light beams PW1 and PW2, as illustrated in FIG. 6(a).

When exposing a phase pit, one of the exposing light beams PW1 is shifted radially to reduce the distance BD between the two beams, as illustarated in FIG. 6(b), and the resist original board 3 is exposed at the same time by those exposing light beams PW1 and PW2.

In this manner, it is possible to form the phase pit P such that the center of the phase pit P is shifted radially by a distance s from the track center of the groove G, the groove width of the phase pit P is smaller than that of the groove G, and the phase pit is asymmetrical relative to the track center.

Namely, by controlling the beam distance and the light intensity of the two exposing light beam PW1 and PW2, the resist on maser 3 to expose the location for a groove G or a phase pit P as needed and, therefore, a stable phase pit P can be formed and read.

Third Embodiment

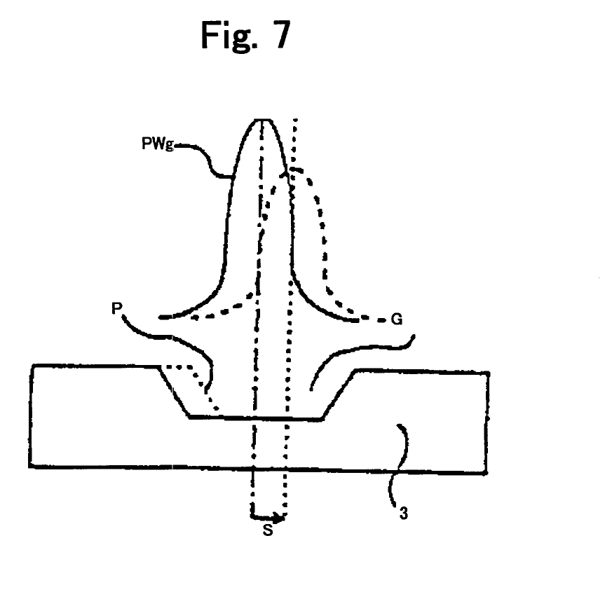

A third embodiment is described hereinafter, referring to FIG. 7.

The third embodiment relates to a method of exposing the resist on the master 3 for forming grooves G and phase pits P in the configurations illustrated in FIGS. 5(a) through 5(c). In this third embodiment, only one exposing light beam (here, the groove exposing light beam PWg) is employed.

When exposing for the groove G, the groove exposing light beam PWg is centered on the center of the track. This beam is shown by the solid line in FIG. 7. That is the same as in the case of FIG. 4(a).

When exposing for the phase pit P, the groove exposing light beam PWg is shifted by the distance s in the radius direction from the center of the track and the light intensity for exposing the phase pit is made lower than that for exposing the groove. This light beam is shown by the dotted line in FIG. 7.

In this manner, it is possible to form the phase pit P such that, as seen in FIGS. 5(b) and 5(c), the center of the phase pit P is shifted radially by the distance s from the track center of the groove G, the groove width of the phase pit P is smaller than that of the groove G, and the phase pit cross section is offset from and asymmetrical relative to the track center.

Namely, by controlling the amount by which the exposing light bean is shifted radially and by controlling the light intensity of the light beam PWg, the reisist on the maseter 3 can be exposed for forming the groove G and the phase pit P, and a stable phase pit P can be formed.

Fourth Embodiment

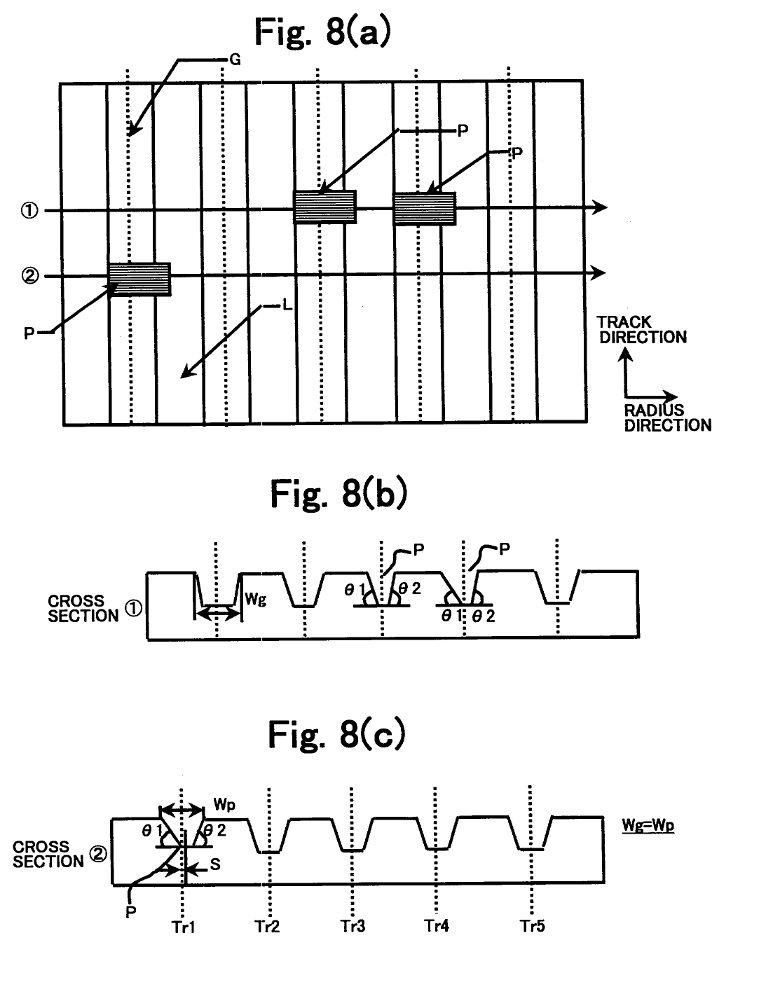

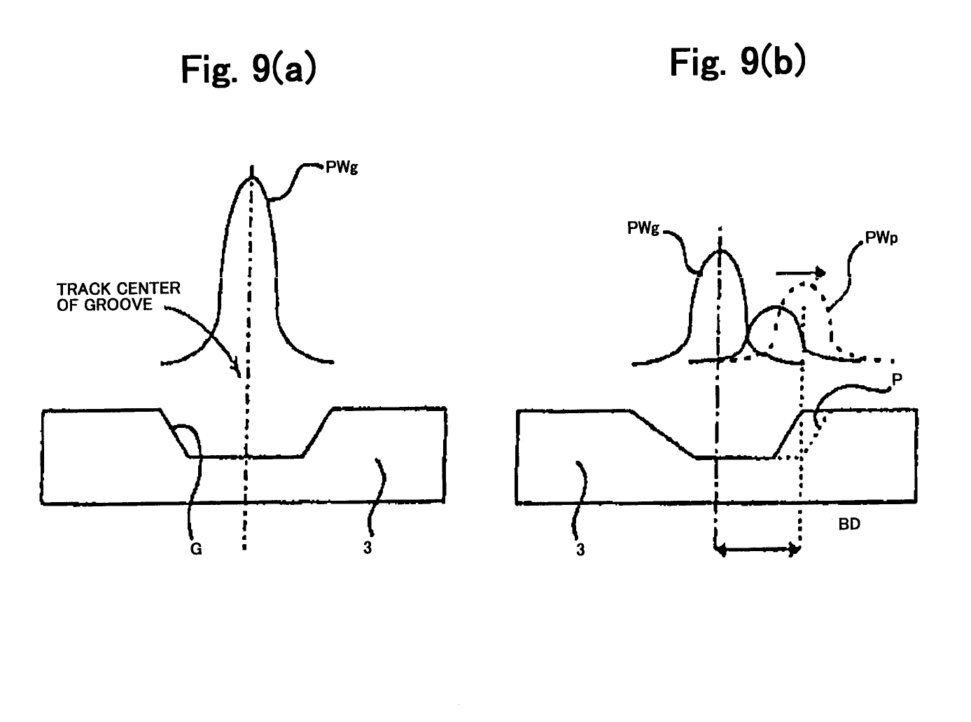

A fourth embodiment is described hereinafter, referring to FIGS. 8(a) through 9(b).

In the fourth embodiment, the phase pit P is formed on the groove G, and the inclination angles of the sides of the phase pit P (right and left) differ in a section in the radius direction perpendicular to the track Tr. Namely, assuming that the inclination angles are θ1 and θ2, respectively, the relationship of θ1 and θ2 is: θ1≠θ2. (Here, the relationship thereof is θ1<θ2.)

The inclination angles of both sides of the groove G equal θ2, and the center of the phase pit P (the center of the radial cross section, at the level of Wp) is shifted by the distance s in the radius direction from the track center of the groove G. The groove width Wp of the phase pit P is set to a value larger than that (Wg) of the groove G (Wg<Wp). The groove depths of both G and P are set to an equal value. Although the groove width Wp of the phase pit P is larger than that (Wg) of the groove G, the groove width Wp is set to the value within a range such that the phase pit P is not connected to the groove G of the adjacent tracks in the radial direction.

As compared with a conventional optical information recording medium as illustrated in FIG. 23, in this fourth embodiment a part of a phase pit P on a groove G and in part is on a land L adjoining that groove G, but the position of the phase pit P and its width Wp are controlled such that the phase pit P does not extend radially to another land L or another groove G. Thereby, the center of the phase pit P can be offset from the center of the groove G, and the phase pit P can be made asymmetrical in the radial direction relative to the center of the groove G.

Therefore, for instance as shown at tracks Tr3 and Tr4 in FIGS. 8(a) through 8(c), even though two phase pits P exist at adjacent tracks radially next to each other, they are still spaced from each other radially. Consequently, those phase pits P can be stably reproduced and detected form the push-pull signal without causing mutual interference.

A method of exposing the resist on a master 3 for forming the grooves G and the phase pits P of this fourth embodiment illustrated in FIGS. 8(a) through 8(c) is described hereinafter, referring to FIG. 9. Two exposing light beams are employed in order to expose the groove G and the phase pit P. One of the beams is the groove exposing light beam PWg centered at the track center of the groove G, and the other is the phase pit exposing light beam PWp shifted by the distance BD in the radius direction from the track center.

When exposing for the groove, the resist on master 3 is exposed by use of only the groove exposing light beam PWg centered at the track center (shown by the dot-and dash line) as seen in FIG. 9(a). That is the same as in FIG. 4(a).

When exposing for the phase pit, utilizing the principle controlling the inclination angles of the sides of the phase pit P by controlling the light intensity of the exposing light beam as earlier discussed, the light intensity of the groove exposing light beam PWg is made decreased as compared with using it for exposing for the groove G as seen in FIG. 9(b), and the exposing light beam PWp for the phase pit, centered at a point shifted radially by the distance BD from the track center, is used at the same time used in order to increase the inclination angle at one side of the phase pit P [in FIG. 9(b), right side]. Thus, the resist on master 3 is exposed at the same time with the two exposing light beams PWg and PWp.

As seen in FIG. 9(b), the light intensity of the phase pit exposing light beam PWp is set to the value lower than that of the groove exposing light beam PWg. Here, in comparison with the method of exposing the original board for forming the phase pit P of the type seen in FIG. 1, the distance BD between the exposing light beams PWg and PWp is greater than that shown in FIG. 4(c), and the light intensity of the phase pit exposing light beam PWp is set to a somewhat higher value as shown by the dotted line in FIG. 9(b). Namely, in order to widen the groove width Wp of the phase pit P radially, the distance between the exposing light beam PWg and PWp is made greater than that in the method illustrated in FIG. 4, and the light intensity of the phase pit exposing light beam is set to the value a somewhat greater than that of the phase pit exposing beam PWp of FIG. 4.

Though this process, it is possible to form the configuration illustrated in FIGS. 8(a) through 8(c), where the center of the phase pit P (at the level of width Wp) is shifted by the distance s from the track center of the groove G, the relationship between the inclination angles θ1 and θ2 of the left and right sides of phase pit P is θ1<θ2, the groove width Wp of the phase pit P is greater than the width (Wg) the groove G, and the phase pit P's radial section is asymmetrical relative to the track center.

Namely, since the resist on the master 3 for the groove G and that for the phase pit P can be exposed by controlling the position and spacing and the light intensity of the he exposing light beams PWg and PWp, the phase pit P can be formed stably and precisely.

Fifth Embodiment

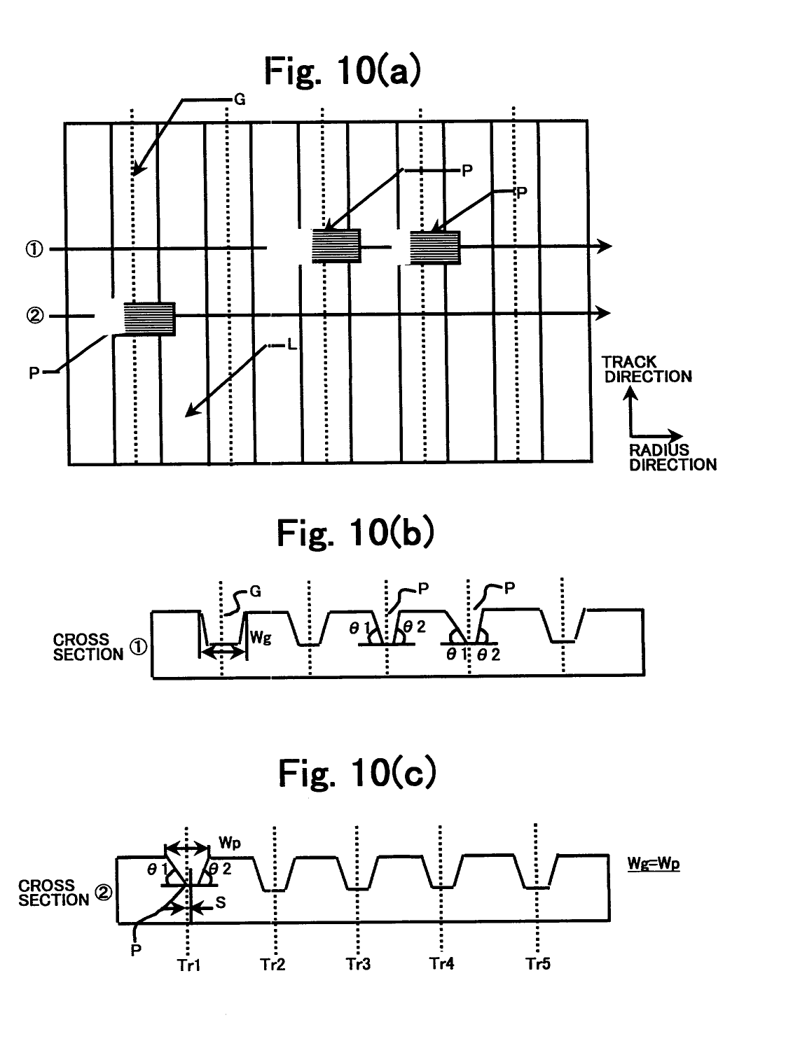

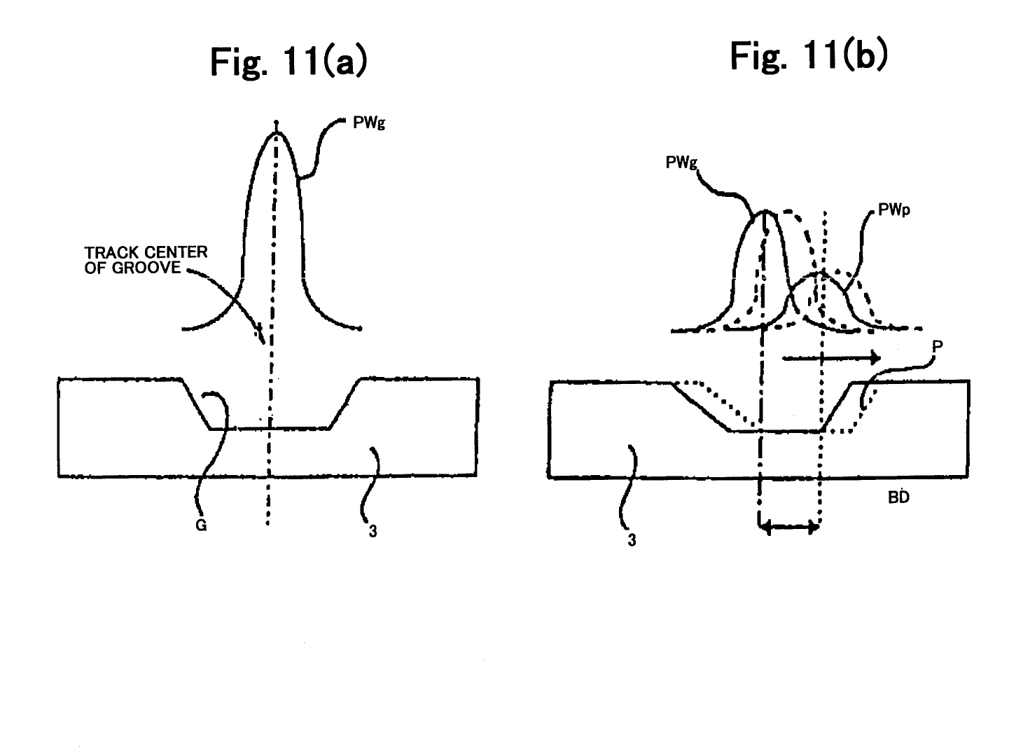

A fifth embodiment is described hereinafter, referring to FIGS. 10(a) through 11(b).

In the optical information recording medium of the fifth embodiment, the phase pit P is formed on the groove G and the inclination angles of the sides of the phase pit P (right and left) in the radius direction perpendicular to the track Tr, are made different from each other. Namely, assuming that the inclination angles at the edge portions are respectively θ1 and θ2, the relationship between the angles is θ1≠θ2 (here, θ1<θ2).

The inclination angles of the sides of the groove G are both equal to θ2. The center of the width Wp of the phase pit P is shifted by the distance s in the radius direction from the track center of the groove G. The widths Wg of the groove G and Wp of the phase pit P are the same (Wg=Wp), and the depths of both also are the same. The shift amount s from the track center of the phase pit P is set such that a phase pit P remains spaced from an adjacent groove G in the radial direction.

As compared with a conventional optical information recording medium of the type illustrated in FIG. 23, although in this fifth embodiment a part of the phase pit P extends radially to the land L, the shift amount s is controlled such that the phase pit P does not connect to the groove G of the adjacent tracks, and the width Wp of the phase pit P can be made asymmetrical relativea to the track center of the groove G. Consequently, for instance, as seen at tracks Tr3 and Tr4, even though two phase pits P are next to each other in the radial direction on two adjacent tracks, it is possible to arrange the phase pits P such that they remain radially spaced from each other and can be stably reproduced and detected from the push-pull signal without mutual interference.

The method of exposing the original board for forming the groove G including the phase pit P of the present embodiment status as shown in FIG. 10 is described hereinafter, referring to FIG. 11. The present embodiment status also uses the two lines of the exposing light beam for exposing the groove G and the phase pit P. One of those beams is the groove exposing light beam PWg disposed on the track center of the groove G, and another one of those beams is the phase pit exposing light beam PWp shifted by the distance BD in the radius direction from the track center.

When exposing the resist on the master 3 for forming the groove, only one groove exposing light beam PWg is used, centered at the track center as shown by dot-and-dash line in FIG. 11(a). The method is same as that of FIG. 4(a).

When exposing for forming the phase pit, utilizing the principle of controlling the inclination angle of the sides of the phase pit by controlling the light intensity of the exposing light beam as mentioned before, as seen in FIG. 11(b), the light intensity of the groove exposing light beam PWg is made smaller than that at the time of exposing for forming the groove G, and the resist on master 3 is exposed at the same time with the two exposing light beams PWg and PWp, with the phase pit exposing light beam PWp spaced radially from the track center) by the spacing BD in order to increase the inclination angle of one side of the phase pit P [in FIG. 11(b), right side].

As seen in FIG. 11(b), the light intensity of the phase pit exposing light beam PWp is set to a lower value than that of the groove exposing light beam PWg. In order to shift the center of the phase pit P in the radius direction from the track center, the two exposing light beam PWg and PWp are shifted at the same time by the distance s in the radius direction from the track center as shown by the dotted line in FIG. 11(b).

By exposing the resist on the master 3 in this manner, it is possible to form the structure illustrated in FIGS. 10(a) through 10(c), where the center of the width Wp of the phase pit P is shifted radially by the distance s from the track center of the groove G, the relationship between the inclination angles θ1 and θ2 of sides of the phase pit P is θ1<θ2, and the phase pit P is asymmetrical relative to the track center.

Namely, since the resist on the master 3 can be exposed for forming the groove G and the phase pit P by controlling the beam positions and spacing and the light intensity of the two exposing light beams PWg and PWp, the phase pit P can be stably and precisely formed.

Sixth Embodiment

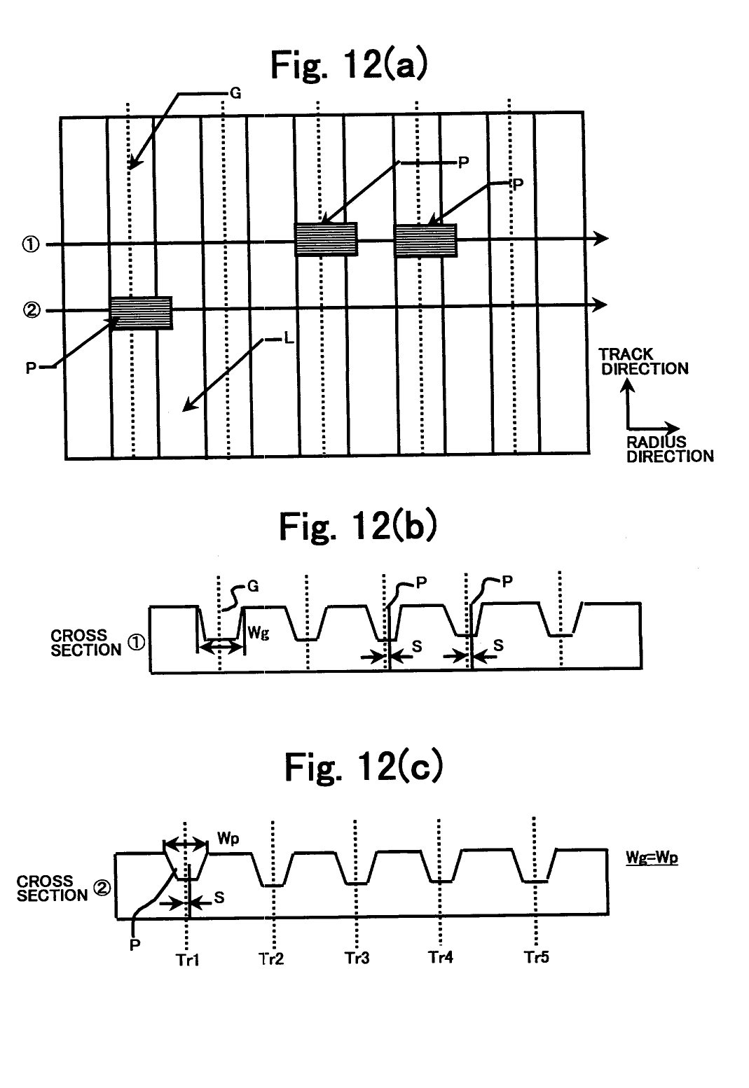

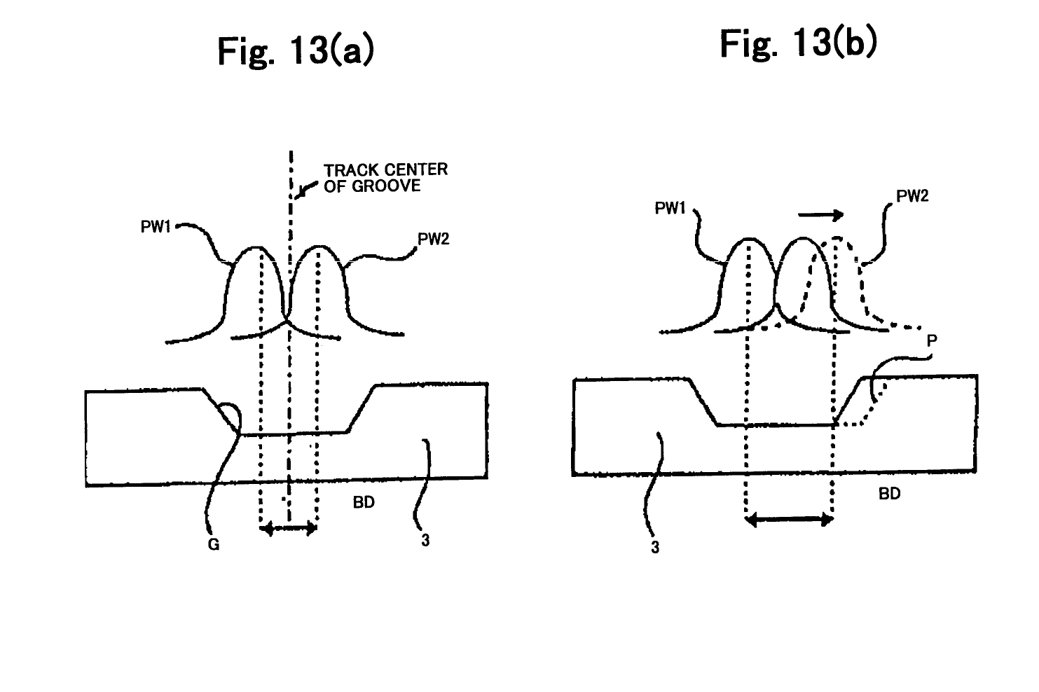

A sixth embodiment is described hereinafter, referring to FIGS. 12 and 13.

In the optical information recording medium of the sixth embodiment, the phase pit P is formed on the groove G and the center of the radial cross section of the phase pit P is shifted by the distance s in the radius direction from the track center of the groove G. The groove width Wp of the phase pit P is greater than the groove width Wg of the groove G (Wg<Wp), and the depths of both are equal.

Although the width Wp of the phase pit P is more than the groove width Wg of the groove G, the width Wp is set such that the phase pit P does not connect to the groove G of the adjacent tracks. The inclination angles of the sides of the phase pit P (right and left) in the radius direction perpendicular to the track Tr are set to an equal value. (The inclination angles of the sides of the groove G also are equal.)

As compared with a conventional optical information recording medium of the type illustrated in FIG. 23, although the phase pit P of this sixth embodiment extends into a part of the land L, the width of the phase pit P in controlled such that the phase pit P does not connect to the groove G of the adjacent tracks, and in radial cross section the phase pit P is asymmetrical relative to the track center of the groove G. Consequently, for instance, as shown by the tracks Tr3 and Tr4, even if two phase pits P exist side-by-side in the radial direction at the adjacent tracks, those phase pits P can be stably reproduced and detected from the push-pull signal without mutual interference.

A method of exposing the resist on the master 3 in order to form a groove G and a phase pit P according to this sixth embodiment, as illustrate in FIGS. 12(a) through 12(c) is described hereinafter, referring to FIGS. 13(a) and 13(b). Two exposing light beams PW1 and PW2 are used for exposing the groove G and the phase pit P. The light intensities of those exposing light beams PW1 and PW2 are set to an equal value, and the two beams are separated by the distance BD in the radius direction.

When the resist on the master 3 is being exposed for forming the groove, both of the exposing light beams PW1 and PW2 symmetrically flank the track center (shown by dot-and-dash line) in the racial direction, as seen in FIG. 13(a). The resist on the master 3 is exposed at the same time with those exposing light beams PW1 and PW2. The method is same as that of FIG. 6(a).

In order to exponse the resist on the master 3 for forming the phase pit P, as shown by the dotted line in FIG. 13(b), the exposing light beam PW2 is shifted in a radial direction to increase the distance BD between the two beams. The resist on the master 3 is exposed at the same time with both exposing light beams PW1 and PW2.

By carrying out such exposure of the master 3 in order to form grooves and phase pits of the type illustrated in FIGS. 12(a) through 12(c), it is possible to form the phase pit P such that the center of the phase pit P is shifted radially by the distance s from the track center of the groove G, the groove width Wp of the phase pit P is made greater than that (Wg) of the groove G, and the phase pit P has a radial cross section that is asymmetrical relative to the track center. The resist on the master 3 can be exposed for forming the groove G and the phase pit P by controlling the distance between, and the light intensity of, the two exposing light beam PW1 and PW2 so as to form the phase pit P stably and precisely.

Seventh Embodiment

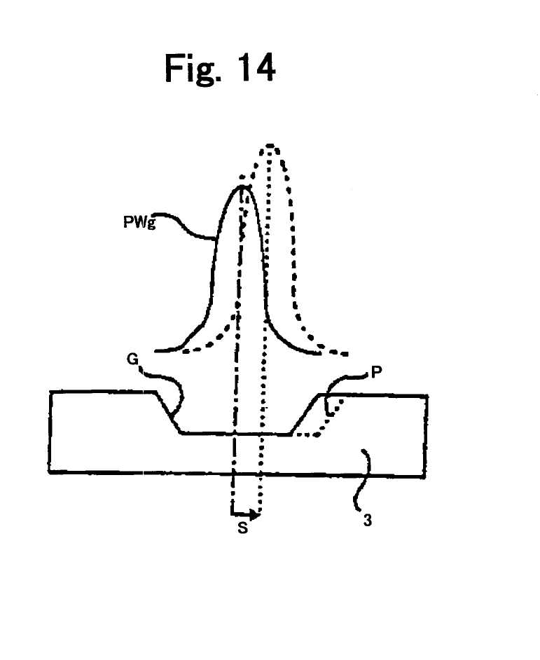

A seventh embodiment is described hereinafter, referring to FIG. 14. The seventh embodiment relates to a method of exposing the resist on the master 3 for forming a groove G and a phase pit P of the type illustrated in FIGS. 12(a) through 12(c).

In the seventh emboument, only one exposing light beam (here, the groove exposing light beam PWg) is employed.

At the time of exposure for forming the groove, the groove exposing light beam PWg is centered at the track center and the resist on the master 3 is exposed as shown by the solid line in FIG. 14. The method is same as that of FIG. 4(a).

At the time or exposing the resist on the master 3 for forming the phase pit, the groove exposing beam PWg is shifted by the distance s in the radius direction from the track center and its light intensity is increased as compared with the case of exposing the groove, as shown by the dotted line in FIG. 14. The resist is exposed in this shifted position and at this increased intensity of the beam PWg in order to form the phase pit.

Though practicing this method of exposing the resist on the master 3, it is possible to achieve the configuration illustrated in FIGS. 12(a) through 12(c), where the venter of the phase pit P is shifted by the distance s from the track center, the phase pit groove width Wp of the phase pit P is greater than that (Wg) of the groove G, and the phase pit P has a radial cross sections that is asymmetrical relative to the track center.

Namely, by controlling the degree of shifting and the light intensity of the groove exposing light beam PWg, the resist on the master 3 can be exposed appropriately for forming the groove G and the phase pit P, and the phase pit P can be formed stably and precisely.

Eighth Embodiment

An eighth embodiment is described hereinafter, referring to FIGS. 5, 15 and 16.

In an optical information recording medium according to the eighth embodiment, the phase pit P is formed at the groove G, and the center of the phase pit P (the center of the phase pit in a radial cross section) is shifted by the distance s in the radius direction from the track center of the groove G. The shifting amount s of the phase pit P from the track center is selected such that the phase pit P is not connected to the groove G of either adjacent track. The groove width Wg of the groove G and that Wp of the phase pit P are set to an equal value (Wg=Wp). The groove depths of the groove G and the phase pit P are also set to another equal value. The inclination angles os the sides of the phase pit P (in a radial section perpendicular to the track Tr) are also set to an equal value.

As compared with a conventional optical information recording medium of the type illustrated in FIG. 23, in the 8th embodiment a part of the phase pit P is at a groove and a part is at a land but, cy controlling the amount of offset or shifting, the phase pit is prevented from connecting to a groove G of an adjacent tracks. In radial section, the phase pit P is asymmetrical relative to the track center. Therefore, for instance as shown at tracks Tr 3 and Tr4, even if two phase pits P exist side-by-side in the radial direction at two adjacent tracks, those phase pits P can be stably reproduced and detected from the push-pull signal, without mutual interference.

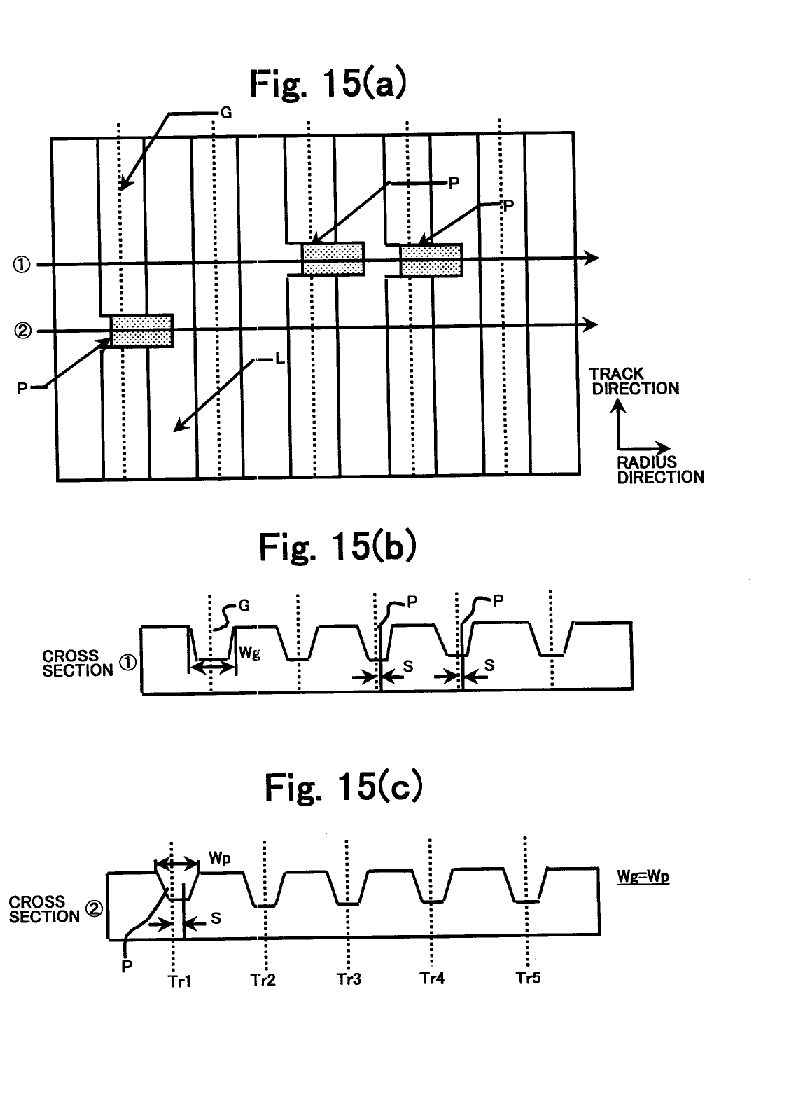

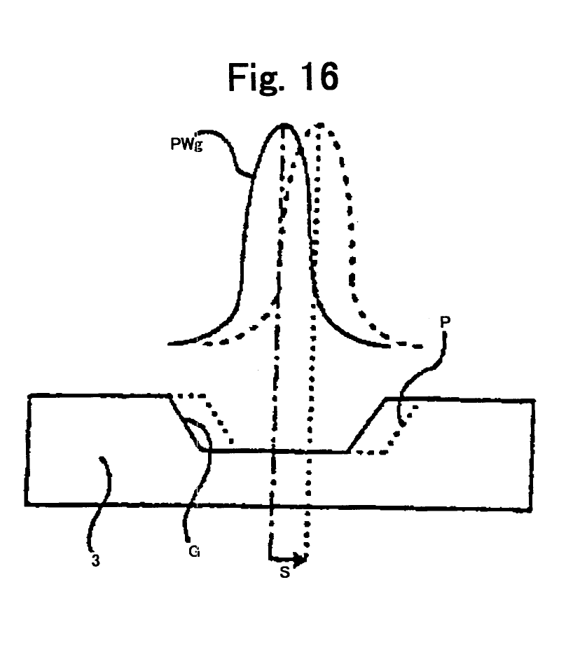

A method of exposing the resist on the master 3 for forming the groove G and the phase pit P of the 8th embodiment, in the configuratiuon illustrated in FIGS. 15(a) through 15(c), is described hereinafter referring to FIG. 16. Only one exposing light beam (here, the groove exposing light beam PWg) is employed.

At the time of exposing the resist on the master 3 for forming the groove, the exposing light beam PWg is centered at the track center, as shown by the solid line in FIG. 16. The method is same as that of FIG. 4(a).

For exposing the resist on the master 3 for forming the phase pit, the groove exposing light beam PWg is shifted by the distance s from the track center, as shown by the dotted line in FIG. 16. The exposure for the phase pit takes place with the beam so shifted.

Through this method of exposing the resist on the master 3 to achieve a structure of the type illustrated in FIGS. 12(a) through 12(c), it is possible to form the phase pit P such that in radial section its center is spaced radially by the distance s from the track center, and the phase pit P in radial section is asymmetrical relative to the track center. Namely, by controlling the amount of offset or shift and the light intensity of the groove exposing light beam, the phase pit P can be formed stably and precisely.

### RESULTS

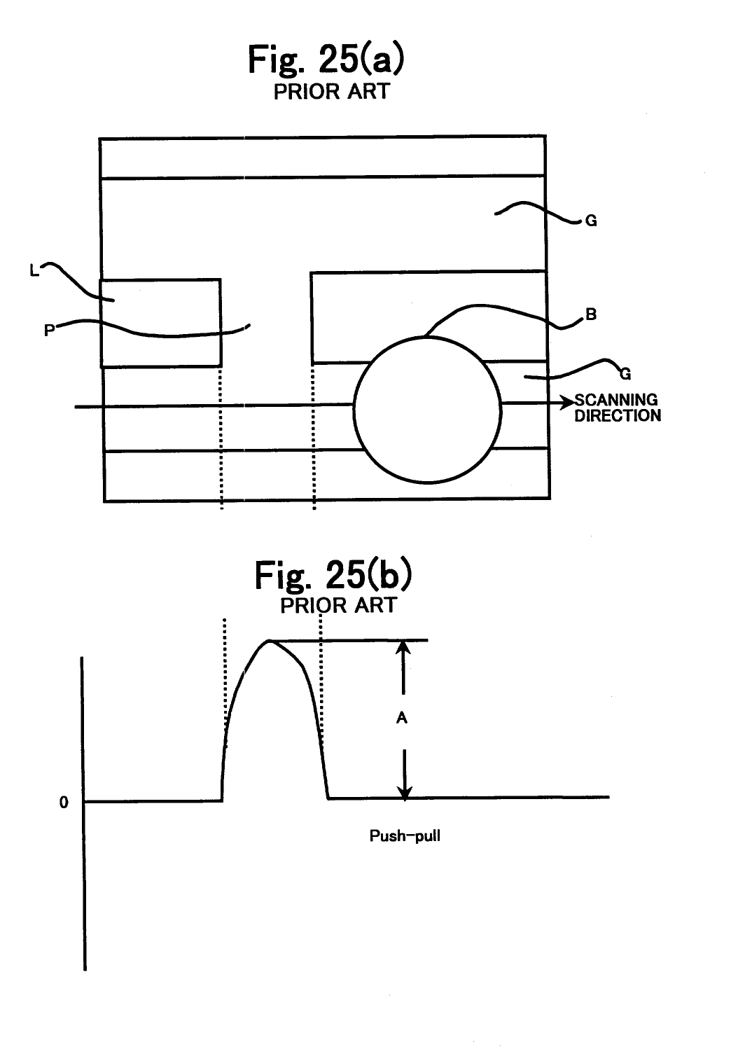

As earlier discussed in connection with FIGS. 25(a) and 25(b), there is a relationship between the shape and position of the phase pit P relative to the groove G and the difference value A of the push-pull signal at the phase pit. In the discussion below, a numerical value LPP is used for convenience, obtained by dividing the value A of the push-pull signal by the sum signal (level) at the time of reading the groove G (and the phase pits thereat). For reading, a reproducing beam B is used comprising a laser beam having a wavelength of 635 nm and a beam diameter of approximately 0.9 μm. The track pitch TP is approximately 0.8 μm. Phase change recording material is used as the recording medium along the tracks, formed as a recording film on a substrate that carries other layers as well, including a protective layer.

### First Example

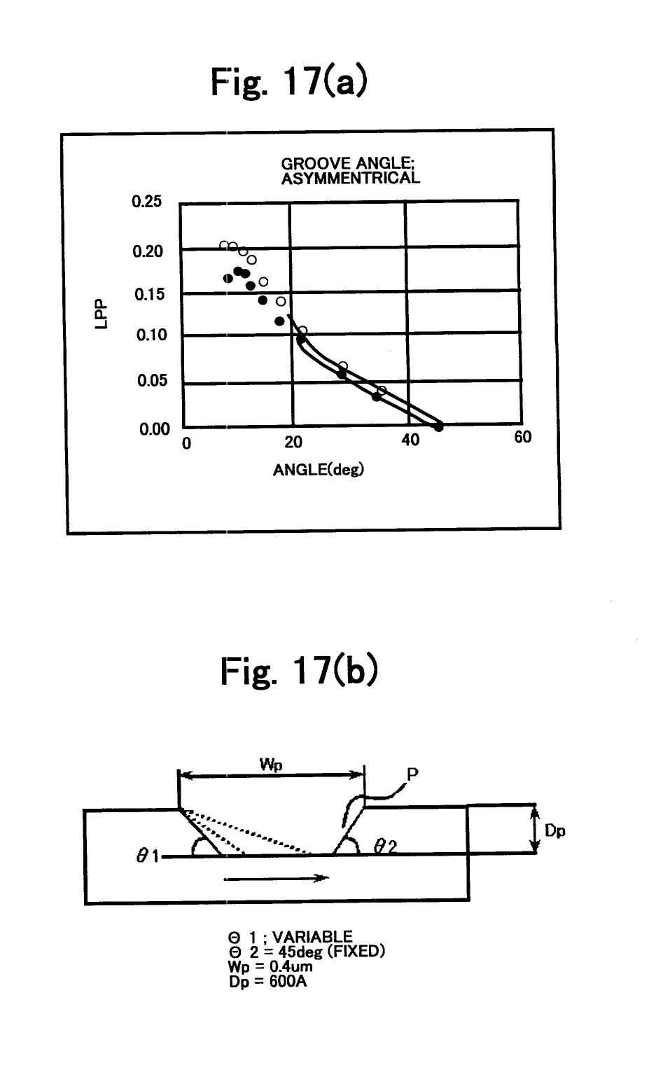

Results regarding the first embodiment, illustrated in FIGS. 1(a) through 1(c), are described hereinafter, referring to FIG. 17(a) and 17(b) illustrating the effect on LPP of varying the inclination angle θ1 of one side (in radial section) of the phase pit P. In this example, the angle θ2 of the other side, e.g., the right-hand side in FIG. 17(b), is fixed at θ2=45°. The width Wp of the phase pit P is set to 0.4 μm and the groove depth thereof is set to 600 Å.

In FIG. 17(a), the mark “◯” represents the numerical value of LPP when reading a phase pit when no other phase pit is radially adjacent thereto at an adjacent track, while the mark “●” represents the numerical value of LPP when reading a phase pit that has another phase pit radially adjacent thereto at an adjacent track (so that the two phase pits that are radially side-by-side could potentially interfere with each other).

In order to produce the appropriate configuration of grooves and phase pits through exposure of the resist on the master 3 for this example, two exposing light beams are used, as discussed in connection with FIGS. 4(a) through 4(c), and samples that differ from each other in various parameters can be made by suitably controlling the distance between the exposing light beams and the light intensities thereof.

According to the illustration of FIG. 17(a), when there is no radially adjacent phase pit to the one being read, in general the smaller the inclination angle θ1 at one side of the phase pit (in radial section), the greater the value of LPP, and the inclination angle of θ1≈10° yields a maximum value of LPP (LPP≈0.20).

As illustrated in FIG. 17(a), even when there is a radially adjacent phase pit at the next track, as shown by the mark “●”, the value of LPP decreases by only up to approximately 0.05, in comparison with the case shown by the mark “◯”. It can be appreciated that an inclination angle of θ1≈10° enhances the stability of the LLP signal and the stable detection of the phase pits even when two phase pits are radially side-by-side at adjacent tracks.

### Second Example

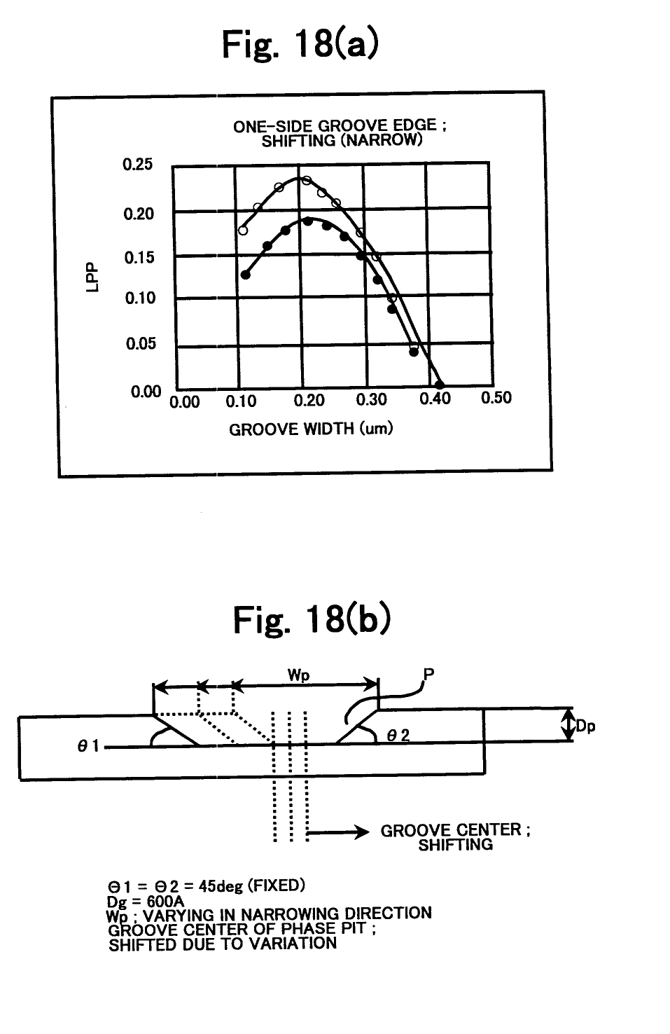

Results regarding the second embodiment, illustrated in FIGS. 5(a) through 5(c), are described hereinafter, referring to FIGS. 18(a) and 18(b) illustrating the effect on LPP of radially shifting only one side (in radial section) of the phase pit P to thereby reduce the width Wp of the phase pit P.

As illustrated in FIG. 11(b), both of the inclination angles θ1 and θ2 at the sides (in radial section) of the phase pit are 45°. The width Wp and depth Dp of the phase pit P are respectively 0.4 μm and 600 Å. In FIG. 18(a), the mark “◯” represents the numerical value of LPP from reading a phase pit when no other phase pit is radially adjacent thereto at an adjacent track, while the mark “◯” represents the numerical value of LPP from reading a phase pit when another phase pit is radially adjacent thereto at an adjacent track (so that the two phase pits that are radially side-by-side could potentially interfere with each other). Two exposing beams were used, as discussed in connection with FIGS. 6(a) and 6(b) to produce samples having different parameters by controlling the distance between the exposing light beams and the light intensities thereof.

As illustrated in FIG. 18(a), even when there is a radially adjacent phase pit at the next track, as shown by the mark “●”, the value of LPP decreases by only up to approximately 0.05, in comparison with the case as shown by the mark “◯”. It can be appreciated that the presence of two radially adjacent phase pits does not cause significant interference.

In the case of the second embodiment, it is preferable that the width Wp of the phase pit P be approximately 0.2 μm and the center (in radial section) of the phase pit be shifrte radially from the track center by approximately 0.06 μm.

### Third Example

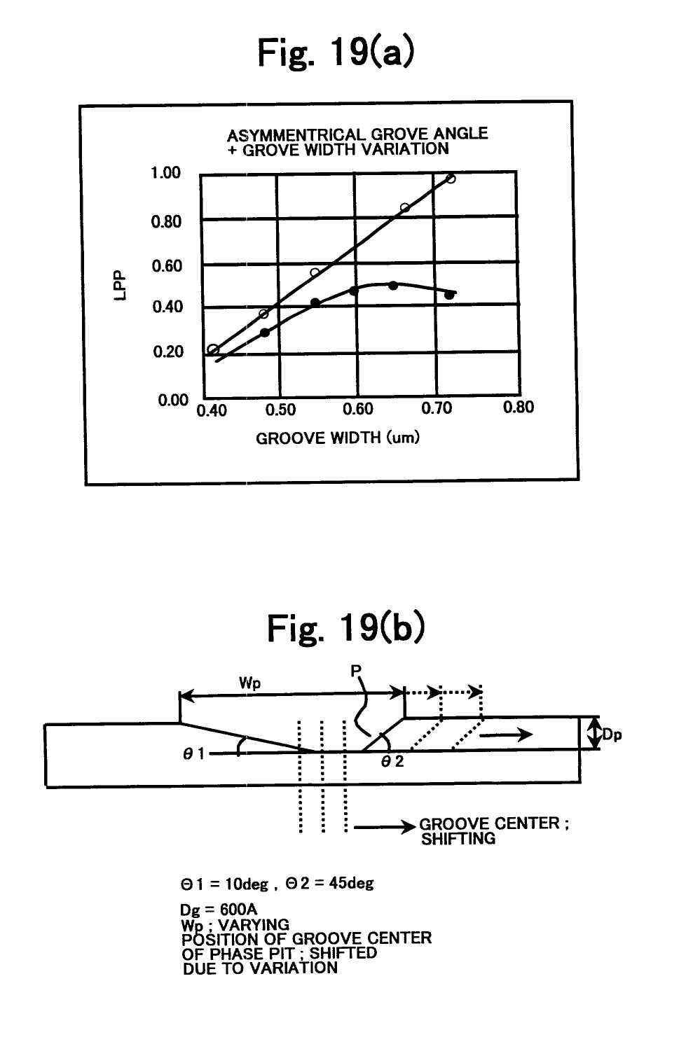

Results related to the fourth embodiment, illustrated in FIGS. 8(a) through 8(c), are described hereinafter, referring to FIGS. 19(a) and 19(b). In that fourth embodiment, the inclination angles θ1 and θ2 at of the sides (in radial section) of the phase pit are different from each other. FIGS. 19(a) and 19(b) illustrate the effect on LPP of shifting only ones side of the phase pit P to thereby increase the width Wp (while maintaining the two different inclination angles).

As illustrated in FIG. 19(b), the inclination angles are:

θ1=10°, and θ2=45°.

The depth Dp of the phase pit P is 600 Å. In FIG. 19(a), the mark “◯” represents the numerical value of LPP from reading a phase pit when no other phase pit is radially adjacent thereto at an adjacent track, while the mark “●” represents the numerical value of LPP from reading a phase pit when another phase pit is radially adjacent thereto at an adjacent track (so that the the two phase pits that are radially side-by-side could potentially interfere with each other). Two exposing beams were used, as discussed in connection with FIGS. 9(a) and 9(b) to produce samples having different parameters by controlling the distance between the exposing light beams and the light intensities thereof.

As illustrated in FIG. 19(a), even when there is a radially adjacent phase pit at the next track, as shown by the mark “●”, the value of LPP decreases by only up to approximately 0.05, in comparison with the case as shown by the mark “◯”. It can be appreciated that the presence of two radially adjacent phase pits does not cause significant interference.

As seen in FIG. 19(a), in the case of the fourth embodiment (FIGS. 8(a)-8(c)) it is preferable that the width Wp of the phase pit P be greater than in the case of the first embodiment (FIGS. 1(a) through 1(c)) and that the center of the phase pit (in radial section) be shifted in the arrow direction, so as to increase the value of LLP. A suitable width Wp is approximately 0.65 μm.

In order to ensure reliably that no phase pit P extends into a groove G of an adjacent tracks, it is preferable to keep the width Wp of the phase pit P in the range of 0.5 through 0.7 μ?m when a track pitch PT of approximately 0.8 μm is used, taking into account probabilities inherent in manufacturing such as those involving variations in the track pitch TP and light intensity variation of the respective beams.

### Fourth Example

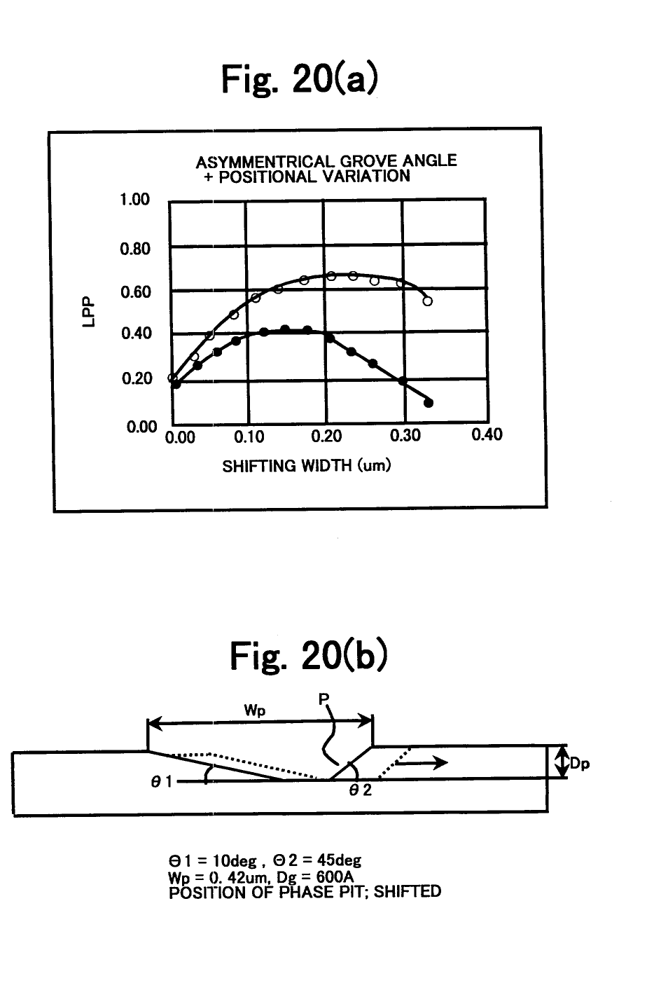

Results related to the fifth embodiment, illustated in FIGS. 10(a) through 10(c)), are described hereinafter referring to FIGS. 20(a) and 20(b). In the fifth embodiment, the inclination angles θ1 and θ2 at the sides (right and left) in a radial section through the phase pit are different from each other, where

θ1=10°, and θ2=45°

The width Wp of the phase pit P is 0.4 μm, as is the groove G, and the depth Dp of the phase pit is 600 Å. In FIG. 20(a), the mark “◯” represents the numerical value of LPP from reading a phase pit when no other phase pit is radially adjacent thereto at an adjacent track, while the mark “●” represents the numerical value of LPP from reading a phase pit when another phase pit is radially adjacent thereto at an adjacent track (so that the the two phase pits that are radially side-by-side could potentially interfere with each other). Two exposing beams were used, as discussed in connection with FIGS. 11(a) and 11(b) to produce samples having different parameters by controlling the distance between the exposing light beams and the light intensities thereof.

As illustrated in FIG. 20(a), as the phase pit P is shifted further from the track center in the radius direction, the value of LPP increases until the shift reaches approximately 0.15 μm, and the value of LLP is optimum at approximately that range.

### Fifth Example

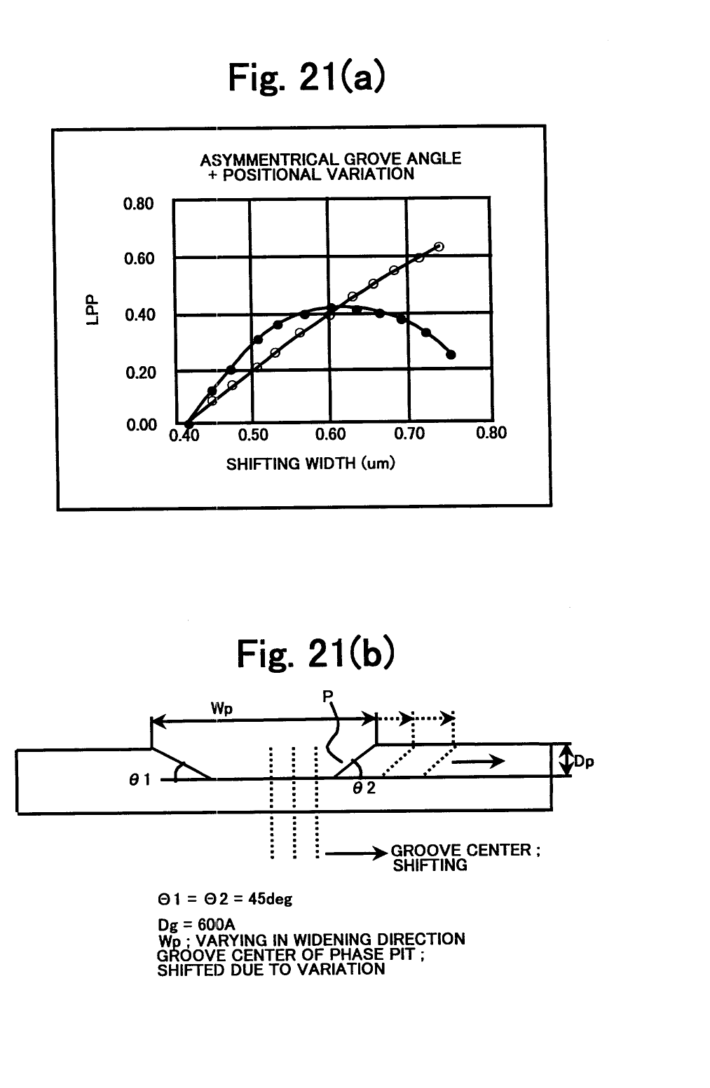

Results regarding the sixth embodiment, illustrated in FIGS. 12(a) through 12(c), are discussed below in connection with FIGS. 21(a) and 21(b). In the sixth embodiment, the inclination angles θ1 and θ2 of the sides (right and left) of the phase pit in radial section are equal to each other, e.g.

θ1=θ2=45°.

the depth Dp of the phase pit P is 600 Å and the widths Wp and Wg are the same. FIG. 21(a), illustrates the effect on the value of LLP of shifting only the one side (in radial section) of the phase pit P to thereby increase the width Wp of the phase pit P, where the mark “◯” represents the numerical value of LPP from reading a phase pit when no other phase pit is radially adjacent thereto at an adjacent track, while the mark “●” represents the numerical value of LPP from reading a phase pit when another phase pit is radially adjacent thereto at an adjacent track (so that the the two phase pits that are radially sideby-side could potentially interfere with each other). Two exposing beams were used, as discussed in connection with FIGS. 13(a) and 13(b) to produce samples having different parameters by controlling the distance between the exposing light beams and the light intensities thereof. As illustrated in FIG. 20(a), as the phase pit P is made wider and the center thereof (in radial section) is shifter more from the track center, the value of LPP increases until the value of LLP becomes optimal at approximately 0.60 μm shift, where the value of LLP is approximately 0.40 when two phase pits are side-by-side in the radial direction at two adjacent tracks.

### Sixth Example

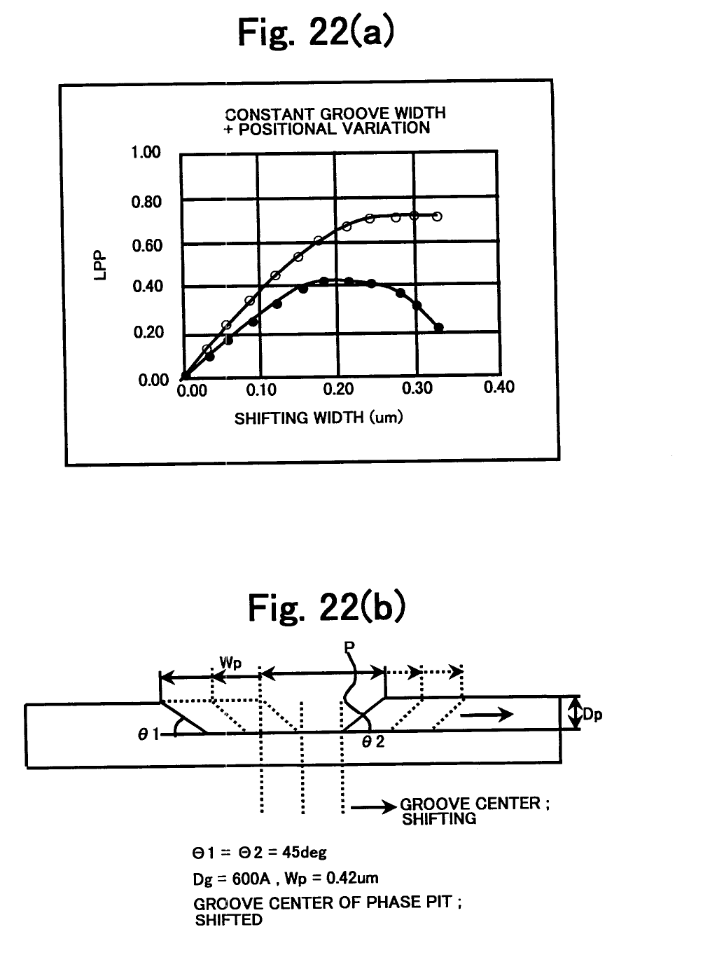

Results regarding the eighth embodiment, illustrated in FIGS. 15(a) through 15(c), are discussed below in connection with FIGS. 22(a) and 22(b). In the eighth embodiment, the inclination angles θ1 and θ2 of the sides (right and left) of the phase pit in radial section are equal to each other, e.g.

θ1=θ2=45°.

the depth Dp of the phase pit P is 600 Å and the widths Wp and Wg are the same. FIG. 22(a), illustrates the effect on the value of LLP of shifting the phase pit P in the radial direction relative to the track, where the mark “◯” represents the numerical value of LPP from reading a phase pit when no other phase pit is radially adjacent thereto at an adjacent track, while the mark “●” represents the numerical value of LPP from reading a phase pit when another phase pit is radially adjacent thereto at an adjacent track (so that the the two phase pits that are radially side-by-side could potentially interfere with each other). One exposing beam was used, as discussed in connection with FIG. 16 to produce samples having shift values.

As illustrated in FIG. 22(a), as the center (in radial section) of the phase pit P is shifted further in the radial direction from the track center, the value of LPP increases until the value of LLP becomes optimal at approximately 0.20 μm shift, where the value of LLP is approximately 0.40 when two phase pits are side-by-side in the radial direction at two adjacent tracks.

According to a first aspect of the disclosed optical information recording media, since the phase pit is formed at the groove and the shape of the phase pit in a radial section is made asymmetrical relative to the track center of the groove, the phase pit can be reliably distinguished from the rest of the groove when reproducing the signal and tracking the groove utilizing the push-pull method. Although the phase pit is formed at the groove, there is no significant mutual interference between phase pits even when they are radially adjacent at adjacent tracks.

According to a second aspect of the disclosed optical information recording media, only by making different from each other the inclination angles of the phase pit sides (in radial section) and thereby making asymmetrical the shape of the groove in radial section relative to the track center, the phase pit can be kept from encroaching on the grooves of adjacent tracks and thereby prevent significant mutual interference between phase pits even when they are radially adjacent at adjacent tracks.

According to a third aspect of the disclosed optical information recording media, the center of the phase p-t is shifted from the track center of the groove in the radius direction perpendicular to the track, the width of the phase pit is smaller than that of the groove, the depths of the phase pit and the groove are equal to each other, and the inclination angles of the sides of the phase pit in radial section are equal to each other.

Consequently, only by making the width of the phase pit smaller than that of the groove, shifting the center of the phase pit radially from the track center and thereby obtaining a phase pit which in radial section is asymmetrical relative to the track center, the phase pit can be kept from extending to the groove of an adjacent track, and thereby the phase pit can be read reliably, without significant interference even when there are two radially adjacent phase pits at adjacent tracks.

According to a fourth aspect of the disclosed optical information recording media, the inclination angles of the sides of the phase pit in radial section are made different from each other, the width of the phase pit is increased but not so much that the phase pit would extend to the the groove of the adjacent track, and the shape of the radial sections thereof is made asymmetrical relative to the track center. Thus, the phase pit is kept from extending into the groove of an adjacent track, and the phase pit can be reliably read without significant interference even when two phase pits are radially adjacent at adjacent tracks.

According to a fifth aspect of the disclosed optical information recording media, the inclination angles of he sides of the phase pit in radial section are made different from each other, the phase pit is shifted in the radius direction but not so much that it would extend into the groove of an adjacent tracks, and the radial section thereof is made asymmetrical relative to the track center. Thus, the phase pit is kept from extending into the groove of an adjacent tracks, and the phase pit can be reliably read without significant interference even when two phase pits are radially adjacent at adjacent tracks.

According to a sixth aspect of the disclosed optical information recording media, the width of the phase pit is increased but not so much that the phase pit would extend into the groove of an adjacent tracks, and the radial section thereof is made asymmetrical relative to the track center. Thus, the phase pit is kept from extending into the groove of an adjacent tracks, and the phase pit can be reliably read without significant interference even when two phase pits are radially adjacent at adjacent tracks.

According to a seventh aspect of the disclosed optical information recording media, the phase pit is shifted in the radius direction but not so much that its would extend into the groove of an adjacent track, and the radial section thereof is made asymmetrical relative to the track center. Thus, the phase pit is kept from extending into the groove of an adjacent track, and the phase pit can be reliably read without significant interference even when two phase pits radially adjacent at two adjacent tracks

According to an eighth aspect of the disclosed optical information recording media, since the master can be exposed for forming the groove and the phase pit by controlling the distance between two exposing light beams and the light intensities thereof, the phase pit can be reliably and precisely formed at the time of manufacturing an optical information recording medium according to the second aspect of the disclosed media.

According to a ninth aspect of the disclosed optical information recording media, since the master can be exposed for forming the groove and the phase pit by controlling the distance between two exposing light beams and the light intensities thereof, the phase pit can be formed reliably and precisely at the time of manufacturing the optical information recording medium according to the third aspect of the disclosed media.

According to a tenth aspect of the disclosed optical information recording media, since the master can be exposed for forming the groove and the phase pit by controlling the radial shifting of one exposing light beam and the light intensity thereof, the phase pit can be formed reliably and precisely at the time of manufacturing an optical information recording medium as defined in the third aspect of the disclosed media.

According to an eleventh aspect of the disclosed optical information recording media, since the master can be exposed for forming the groove and the phase pit by controlling the distance between two exposing light beams and the light intensities thereof, the phase pit can be formed reliably and precisely at the time of manufacturing the optical information recording medium as defined in the fourth aspect of the disclosed media.

According to a twelfth aspect of the disclosed optical information recording media, since the master can be exposed for forming the groove and the phase pit by controlling the distance between two exposing light beams and the light intensities thereof, the phase pit can be formed reliably and precisely at the time of manufacturing the optical information recording medium as defined in the fifth aspect of the disclosed media.

According to a thirteenth aspect of the disclosed optical information recording media, since the master can be exposed for forming the groove and the phase pit by controlling the degree of radially shifting one exposing light beam and the light intensity thereof, the phase pit can be formed reliably and precisely at the time of manufacturing the optical information recording medium as defined in the sixth aspect of the disclosed media.

According to a fourteenth aspect of the disclosed optical information recording media, since the master can be exposed for forming the groove and the phase pit by controlling the distance between two exposing light beams and the light intensities thereof, the phase pit can be formed reliably and precisely at the time of manufacturing the optical information recording medium as defined in the sixth aspect of the disclosed media.

According to a fifteenth aspect of the disclosed optical information recording media, since the master can be exposed for forming the groove and the phase pit by controlling the degree of radially shifting one exposing light beam and the light intensity thereof, the phase pit can be formed reliably and precisely at the time of manufacturing the optical information recording medium as defined in the seventh aspect of the disclosed media.

It should be understood that numerous other embodiments or modifications of the present disclosure are possible in light of the above teachings. It is therefore to be understood that within the scope of the appended claims, the disclosed material may be practiced otherwise than as specifically described herein.

Having now fully described various emboduments and aspects of the disclosure, it will be apparent to one of ordinary skill in the art that many changes and modifications can be made thereto without departing from the spirit and scope of the invention as set forth in the claims below.

This application is based on Japanese Patent Application No. JPAP-09-230696, filed on Aug. 27, 1997, the entire contents of which are herein incorporated by reference.

What is claimed is:

1. An optical information recording medium in which a track for recording the information is a groove and pre-format information is formed thereon as phase pit,
wherein said phase pit is formed on said groove and has a shape of groove cross section which is asymmetrical for the track center of said groove.

2. An optical information recording medium in which a track for recording the information is a groove and pre-format information is formed thereon as phase pit,
wherein the track center of said groove is same as the center of said phase pit, the groove width of said groove is same as that of said phase pit, and the groove depth of said groove is same as that of said phase pit, and
wherein the inclination angles of said phase pit at the both-sides edge portions in the radius direction perpendicular to the track of said phase pit are different from each other.

3. An optical information recording medium in which a track for recording the information is a groove and pre-format information is formed thereon as phase pit,
wherein the center of said phase pit shifts from the track center of said groove in a radius direction perpendicular to said track,
wherein the groove width of said phase pit is smaller than that of said groove, and the groove wipth of said groove is same as that of said phase pit, and
wherein the inclination angles of said phase pit at the both-sides edge portions in the radius direction are equal to each other.

4. An optical information recording medium in which a track for recording the information is a groove and pre-format information is formed thereon as phase pit,
wherein the center of said phase pit shifts from the track center of said groove in a radius direction perpendicular to said track,
wherein the groove width of said phase pit is larger than that of said groove in such a range as that said phase pit is not connected to said grooves of said tracks arranged adjacently in the radius direction,
wherein the groove depth of said groove is equal to that of said phase pit, and
wherein the inclination angles of said phase pit at the both-sides edge portions in the radius direction are different from each other.

5. An optical information recording medium in which a track for recording the information is a groove and pre-format information is formed thereon as phase pit,
wherein the center of said phase pit shifts from the track center of said groove in a radius direction perpendicular to said track in such a range as that said phase pit is not connected to said grooves of said tracks neighboring in the radius direction,
wherein the groove width of said is equal to that of said phase pit, and the groove depth of said groove is also equal to that of said phase pit, and
wherein the inclination angles of said phase pit at the both-sides edge portions in the radius direction are different from each other.

6. An optical information recording medium in which a track for recording the information is a groove and pre-format information is formed thereon as phase pit,
wherein the center of said phase pit shifts from the track center of said groove in a radius direction perpendicular to said track,
wherein the groove width of said phase pit is larger than that of said groove in such a range as that said phase pit is not connected to said grooves of said tracks arranged adjacently in the radius direction,
wherein the groove depth of said groove is equal to that of said phase pit, and
wherein the inclination angle of said phase pit at the both-sides edge portions in the radius direction are equal to each other.

7. An optical information recording medium in which a track for . recording the information is a groove and pre-format information is formed thereon as phase pit,
wherein the center of said phase pit shifts from the track center of said groove in a radius direction perpendicular to said track in such a range as that said phase pit is not connected to said grooves of said tracks neighboring in the radius direction,
wherein the groove width of said groove is equal to that of said phase pit, and the groove depth of said groove is also equal to that of said phase pit, and
wherein the inclination angles of said phase pit at the both-sides edge portions in the radius direction are equal to each other.

8. A method of light-exposing an original board for manufacturing the optical information recording medium as defined in claim 2 comprising the steps of:
preparing two lines of exposing beam; a groove exposing beam disposed on the center of track and a phase pit exposing beam disposed on a position shifted from the center of said track in the radius direction;
exposing an original board by use of said groove exposing beam, at the time of exposing said groove; and
simultaneously exposing said original board by use of said groove exposing beam having a light intensity smaller than that of the groove exposing and said phase pit exposing beam having another light intensity further smaller than that of said groove exposing beam, at the time of exposing said phase pit.

9. A method of exposing an original board for manufacturing the optical information recording medium as defined in claim 3 comprising the steps of:
preparing two lines of exposing light beam respectively having equal light intensity and parted from each other in the radius direction;
arranging said two lines of exposing light beam respectively on positions symmetrical in the radius direction from the center of track and simultaneously exposing said original board by use of said beams, at the time of exposing said groove; and
shifting only one of said exposing beams in a direction of narrowing the separation distance between said exposing beams and simultaneously exposing said original board, at the time of exposing said phase pit.

10. A method of light-exposing an original board for manufacturing the optical information recording medium as defined in claim 3 comprising the steps of:
disposing the exposing light beam on the center of track and exposing said original board by use of a line of said exposing light beam, at the time of exposing said groove; and
shifting said exposing light beam in the radius direction from the center of said track and exposing said original board with the light intensity more lowered than the light intensity of the groove exposing, at the time of exposing said phase pit.

11. A method of exposing an original board for manufacturing the optical information recording medium as defined in claim 4 comprising the steps of:
preparing two lines of exposing beam; a groove exposing beam disposed on the center of track and a phase pit exposing beam disposed on a position shifted from the center of said track in the radius direction;
exposing an original board by use of said groove exposing beam, at the time of exposing said groove; and
simultaneously exposing said original board by use of said groove exposing beam having a light intensity smaller than that of the groove exposing and said phase pit exposing beam having another light intensity further smaller than that of said groove exposing beam, at the time of exposing said phase pit.

12. A method of exposing an original board for manufacturing the optical information recording medium as defined in claim 5 comprising the steps of:
preparing two lines of exposing beam; a groove exposing beam disposed on the center of track and a phase pit exposing beam disposed on a position shifted from the center of said track in the radius direction;
exposing an original board by use of said groove exposing beam, at the time of exposing said groove; and
simultaneously shifting in the radius direction said groove exposing beam having a light intensity smaller than that of the groove exposing and said phase pit exposing beam having another light intensity further smaller than that of said groove exposing beam, at the time of exposing said phase pit, and simultaneously exposing the original board.

13. A method of exposing an original board for manufacturing the optical information recording medium as defined in claim 6 comprising the steps of:
disposing the exposing beam on the center of track and exposing said original board by use of a line of said exposing beam, at the time of exposing said groove; and
shifting said exposing beams in the radius direction from the center of said track, and exposing said original board with the light intensity more raised than the light intensity of the groove exposing, at the time of exposing said phase pit.

14. A method of light-exposing an original board for manufacturing the optical information recording medium as defined in claim 6 comprising the steps of:
preparing two lines of exposing beam respectively having equal light intensity and parted from each other in the radius direction;
arranging said two lines of exposing beam respectively on positions symmetrical in the radius direction from the center of track and simultaneously exposing said original board by use of said beams, at the time of exposing said groove; and
shifting only one of said exposing beams in a direction of widening the separation distance between said exposing beams and simultaneously exposing said original board, at the time of exposing said phase pit.

15. A method of exposing an original board for manufacturing the optical information recording medium as defined in claim 7 comprising the steps of:
preparing a line of exposing beam of constant light intensity;
disposing said exposing light beam on the center of the track and exposing said original board, at the time of exposing said groove; and
shifting said exposing light beam in the radius direction from the center of said track and exposing said original board.

16. A method of forming an optical information recording medium in which a track for recording the information is a groove and pre-format information is formed thereon as phase pit comprising the step of:
forming said phase pit on said groove so as to have a shape of groove cross section which is asymmetrical for the track center of said groove.

17. A method of forming an optical information recording medium in which a track for recording the information is a groove and pre-format information is formed thereon as phase pit comprising the steps of:
making the track center of said groove same as the center of said phase pit;
making the groove width of said groove same as that of said phase pit;
making the groove depth of said groove same as that of said phase pit; and
respectively setting the inclination angles of said phase pit at the both sides edge portions in the radius direction perpendicular to the track of said phase pit to values different from each other.

18. A method of forming an optical information recording medium in which a track for recording the information is a groove and pre-format information is formed thereon as phase pit comprising the steps of:
shifting the center of said phase pit from the track center of said groove in a radius direction perpendicular to said track;
making the groove width of said phase pit smaller than that of said groove;
making the groove depth of said groove is same as that of said phase pit; and
setting the inclination angles of said phase pit at the both-sides edge portions in the radius direction to a value equal to each other.

19. A method of forming an optical information recording medium in which a track for recording the information is groove and pre-format information is formed thereon as phase pit comprising the steps of:
shifting the center of said phase pit from the track center of said grove in a radius direction perpendicular to said track;
making the groove width of said phase pit larger than that of said groove in such a range as that said phase pit is not connected to said grooves of said tracks arranged adjacently in the radius direction;
making the groove depth of said groove equal to that of said phase pit; and
setting the inclination angles of said phase pit at the both-side edge portions in the radius direction to values different from each other.

20. A method of forming an optical information recording medium in which a track for recording the information is a groove and pre-format information is formed thereon as phase pit comprising the step of:
shifting the center of said phase pit from the track center of said groove in a radius direction perpendicular to said track in such a range as that said phase pit is not connected to said grooves of said tracks neighboring in the radius direction;
making the groove width of said equal to that of said phase pit;
making the groove depth of said groove also equal to that of said phase pit, and
setting the inclination angles of said phase pit at the both-sides edge portions in the radius direction to values different from each other.

21. A method of forming an optical recording medium in which a track for recording the information is a groove and pre-format information is formed thereon as phase pit comprising the steps of:
shifting the center of said phase pit from the track center of said groove in a radius direction perpendicular to said track;
making the groove width of said phase pit larger than that of said groove in such a range as that said phase pit is not connected to said grooves of said tracks arranged adjacently in the radius direction;
making the groove depth of said groove equal to that of said phase pit; and
setting the inclination angle of said pit at the both-sides edge portions in the radius direction to a value equal to each other.

22. A method of forming an optical information recording medium in which a track for recording the information is a groove and pre-format information is formed thereon as phase pit comprising the step of:
shifting the center of said phase pit from the track center of said groove in a radius direction perpendicular to said track in such a range as that said phase pit is not connected to said grooves of said tracks neighboring in the radius direction;
making the groove width of said groove equal to that of said phase pit;
making the groove depth of said groove also equal to that of said phase pit; and
setting the inclination angles of said phase pit at the both-sides edge portion in the radius direction to a value equal to each other.
